(19) United States
(12) Patent Application Publication
(10) Pub. No.: US 2025/0142289 A1
(43) Pub. Date: May 1, 2025

(54) MISSION SPACE

(71) Applicants: HAWKEYE 360, Inc., Herndon, VA (US); HAWKEYE 360, INC., Herndon, VA (US)

(72) Inventors: Hyun Kyu SEO, Herndon, VA (US); Chad Matthew MARGOTTA, Herndon, VA (US); Michael Thomas WERLING, Herndon, VA (US); Tim PAVLICK, Herndon, VA (US)

(73) Assignee: HAWKEYE 360, Inc., Herndon, VA (US)

(21) Appl. No.: 18/685,150

(22) PCT Filed: Aug. 22, 2022
(86) PCT No.: PCT/US2022/041128

§ 371 Date: Feb. 20, 2024

Related U.S. Application Data
(60) Provisional application No. 63/235,338, filed on Aug. 20, 2021.

(51) Int. Cl. H04W 4/029; G01S 5/02

(52) U.S. Cl. CPC H04W 4/029; G01S 5/02524

(57) ABSTRACT

Methods, systems, and apparatus, including computer programs encoded on a computer storage medium, are described for implementing a mission space platform. The platform is configured to identify radio frequency (RF) signals and analytics and generate a graphical interface with a map of a geographic area, where the map includes multiple grid points. For one or more RF signals: the platform determines a respective geolocation of an emitter that emits the RF signal and assigns the RF signal and its corresponding emitter to a grid point of the map based on the respective geolocation. Visual characteristics of grid points in the map are dynamically adjusted, in real time, base on new RF information about the area. The new RF information is provided as an output at the interface by displaying adjustments to the visual characteristics of the grid points.

### TECHNICAL FIELD

The following disclosure relates to techniques for data visualization and geographic mapping of emitter devices.

### BACKGROUND

Various electrical devices emit radio frequency (RF) signals (also referred to as radio signals). For example, communications radios, emergency safety beacons, radars, television broadcast towers, wireless access points, cellular towers, cellular phones, and satellite phones, among other radio emitters, transmit radio signals that can be received by other devices. To determine a location of these signal emitters, localization techniques often rely on some form of triangulation based on a difference measurement of time or frequency of a signal to several receivers. Typically, detectors and timing and frequency estimation techniques are designed for a specific signal of interest.

### SUMMARY

The present disclosure describes a mobile RF signal sensor system that combines with a mission space platform that integrates robust mapping functions, dynamic geographic information processing, and automatic RF signal identification. The combined system and platform advantageously permits real-time tracking of emitter source movement, rendezvous of multiple emitter sources, violations by emitter sources of restricted space and identifying unknown emitter sources. The mission space platform (herein also “mission space” or “user interface platform”) is implemented as a browser-based, RF-data-focused, inherently collaborative, geospatial application. Mission space may be designed for various types of end-users, such as intelligence analysts, satellite communication specialists, cyber professionals, first responders, etc. Mission Space is inherently collaborative in that multiple users can operate in the application, at the same time, and simultaneously see each other's work. For example, as soon as one user makes a change it is seen by others in the group. Mission space incorporates a range of Geographic Information System (GIS) capabilities and standards like the Open Geospatial Consortium (OGC) and open source platforms (https://deck.gl), as well as other tools and data visualization techniques, such as methods for searching and visualizing certain data trends. Mission space is designed or configured to expand these capabilities and provide additional insights and user visualization tools that extend to an RF-data-specific context. For example, if a user selects an identified object, mission space then computes all other possible contacts (in that dynamically loaded set of data) and points out, to the user, other instances of the object, or analytics, that they may not have otherwise know about. Using mission space, a user-selected object can be highlighted in one color (e.g., magenta on screen) and mission space will identify related object and behaviors in a second color (e.g., purple on screen), for ready distinction by an operator.

Mission space includes a set of configurable (e.g., user-configurable) alerts with one or more triggers for automatically reacting and responding to new Geospatial RF events. For example, the configurable alerts can receive new data from multiple sources and automatically trigger one or more actions that are uniquely responsive to different data inputs in the new data streams. The multiple sources can include proprietary RF data, existing Automatic Identification System (AIS) datasets, electro-optical (EO) imagery, synthetic aperture radar (SAR) imagery, organic analytics, analytics derived from third party applications, or a combination of these. In most implementations, mission space is an RF-centric platform that provides (or integrates) GIS platform functionality. For example, mission space can provide a hybrid-operating environment that offers AIS specific tooling overlaid with one or more GIS platform functions, e.g. AIS spoofing where mission space provides both the ‘reported’ AIS latitude & longitude as well as the trilaterated geolocation.

Implementations of the disclosed techniques include unique human interaction designs. methods, apparatus, computer program products and systems for performing the above-described actions. Such a computer program product is embodied in a non-transitory machine-readable medium that stores instructions executable by one or more processors. The instructions are configured to cause the one or more processors to perform the above-described actions. One such system includes one or more sensing devices (e.g., satellite RF detectors, satellite EO inputs, satellite SAR inputs, or other aerial platforms with radio signal detection capabilities), and one or more computing units that are configured to perform the disclosed actions upon receiving radio signals from the sensing device(s). Techniques are executed in a manner that allows AIML to analyze the behavior of both RF emitters and users, from which it optimizes results, progressively learning from actor and user behavior data as time goes on.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is an illustration of an exemplary satellite system architecture for collecting RF signal data from an RF emitter source on the earth surface and downloading the data to a terrestrial receiver at a data processing center implementing a mission space platform.

FIG. 2 is a block diagram of an integrated RF data collection system and mission space platform.

FIG. 3A is an illustration of the various data analytics that are provided by the artificial intelligence and machine learning module of the present invention and FIG. 3B is an illustration of the integrated RF data collection system and mission space platform having an unsupervised learning model providing user behavior monitoring and feedback.

FIG. 4 is a flow diagram of an RF data collection and processing function coupled to a mission space processing function where the data is available for tracking or emitter objects and is automatically revisualized & recalculated.

FIG. 5 is an exemplary screen shot illustrating dynamic updating of onscreen data and analytics according to the present invention.

FIG. 6A is a block diagram illustrating an exemplary work flow within a user organization that employs a playbook and snapshot feature according to the present invention; FIG. 6B is an exemplary snap shot. FIG. 6C illustrates a capture of multiple related RDVs.

FIGS. 7A-7D illustrate exemplary interfaces of the mission space platform for implementing automatic RF identification.

FIG. 8 illustrates an example interface of the mission space platform for implementing a vessel search.

FIG. 9 illustrates a first example interface for mapping tools of the mission space platform.

FIG. 10A illustrates a second example interface for mapping tools of the mission space platform and FIG. 10B illustrates a working API to API call to an EO imagery provider.

FIGS. 11A and 11B illustrate example interfaces of the mission space platform that relate to dynamic data statistics and mini-map features.

FIG. 12 illustrates a first example interface for a heat-map feature of the mission space platform.

FIG. 13 illustrates a second example interface for a heat-map feature of the mission space platform with heatmap blocks translated into the exact signal icons within each heatmap block.

FIG. 14 illustrates a third example interface for a heat-map feature of the mission space platform that shows the user where there is data they may wish to explore.

FIG. 15 is a block diagram of a computing system that can be used in connection with the systems and methods described in this specification.

FIG. 16A illustrates an example configuration interface for a heat-map feature of the mission space platform.

FIG. 16B illustrates example settings and features of a grid point in a map (or heatmap) generated by the mission space platform.

FIG. 17 illustrates an example interface for a time-slider feature of the mission space platform.

FIG. 18 illustrates an exemplary interface with playbooks of the mission space platform.

FIG. 19 illustrates a first example interface for a testing feature of the mission space platform.

FIG. 20 illustrates a second example interface for testing feature of the mission space platform.

FIG. 21 is the main screen for the mission space platform with unique elements labelled and

FIG. 22 is a Mercator map view to a three-dimensional (3D) Globe map view.

### DETAILED DESCRIPTION

Radio geolocation, also referred to simply as geolocation, refers to trilateration operations to locate a radio emitter (e.g., a signal source emitting RF signals) based on analyzing RF signals emitted by the radio emitter. Geolocation is useful for radio spectrum access enforcement, commercial radio use analytics, and security applications where determination of the location of an emitter sending radio signals is indicative of activity. In some cases, locations of radio emitters are determined using one or more of time of arrival, frequency of arrival, time-difference and frequency-difference of arrival combined with reverse trilateration. These techniques are based on knowing certain characteristics about the underlying signal (RF signal) transmitted from an emitter, and tagging or correlating a unique time instant for a set of signals that can be used in calculations.

Some geolocation systems apply specific signal analysis techniques and applications to localize various signal types of interest. For example, a geographic information system (GIS) that employs such techniques is operable to connect people, locations, and data using interactive maps. These systems often leverage data-driven styles (dynamic RF analysis) and intuitive analysis tools, to enable data connections and support localization efforts for signals and emitter detection (collectively, the graphic user interface (GUI) and its features comprise the User Experience (UX)). In some cases, an example GIS implements methods of storing a user's workspace information and relevant application data as well as tracking actions taken to execute a given document or project. Other systems may be operable to display multiple types of geospatial data on a map.

The maps can be certain types of basemaps, such as a maritime map, terrestrial map or other relevant maps. Heatmaps are also generated, dynamically, to show the user a relative density view of the data & analytics onscreen (at that moment). Relative density means that the number of objects and behavioral analytics onscreen, in a given area, is calculated in respect to the total number of objects & events onscreen (at that moment). If the user zooms in, pans, filters, or otherwise changes the total amount of elements onscreen, then the density is dynamically recomputed and shown onscreen via the heatmap and, optionally, in a statistical display on the screen in real time, i.e., as soon as the user activity begins.

The types of geospatial data displayed on a given map can include iconography-based objects (signals), vessel tracks (analytics), or both. The mission space platform includes a capability to: i) annotate a map with text and shapes, ii) generate non-map data visualization (e.g., bar graphs) of geospatial data, and iii) manipulate or filter geospatial data based on corresponding meta-data that allows for altering map and non-map views. The meta-data can be associated with location polygons, time information, and column data, including frequency values, pulse-repetition-rate, and flag of a vessel, etc. An exemplary system can include data tabulation features that allow for performing a search on available data to visualize trends of chosen column data.

The mission space platform includes, or is integrated with, AIS signals that employ advanced filtering and search capabilities to view or track position and movement information for various nautical vessels across different geographic locations. For example, the conventional AIS platforms can generate an alert to indicate when an entity or emitter with ID: “123456789” is detected within “Boundary_Name_1.” Some of these platforms can provide live as well as historical activity views of one or more vessels and may include an example watch list that allows for monitoring and accessing information about items of interest, such as a group of vessels A, B, and C.

Given this background, the present disclosure describes a mission space system or platform that integrates robust signal mapping, geographic information processing, dynamic analytics, AIML, and automatic RF signal identification. The mission space system is configured to generate various map views (e.g., graphical interfaces) that visualize the system's collection of RF data and outputs of analytics applied across time and space. For example, the system can visualize various types of RF signal data and apply one or more analytical processes across time and space to identify patterns, understand trends in the signals & analytics data, and improve situational awareness through an intuitive interactive interface.

Mission space is operable to generate one or more heatmaps and corresponding grids, which may be associated with a given map view. An example heatmap grid is configured to provide the relative density of RF signal data and analytics hot spots and detailed insights about identified emitters. For each identified emitter and its corresponding RF signal, mission space can generate and append contextual information about the emitter. The contextual information can be notated by symbols to provide various insights about the emitter or signal. In some implementations, mission space derives a set of metadata for each emitter and generates a summary view of RF data, identified RF signals of the emitter, and contextual information within a map frame based on the metadata.

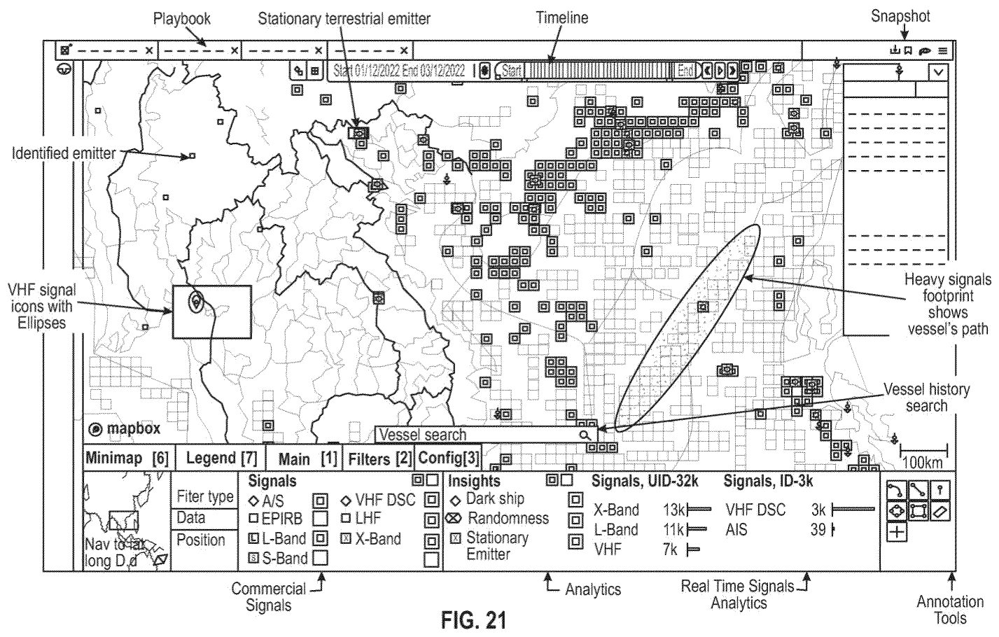

FIG. 21 illustrates a user interface related to processing provided by the mission space platform. The screen includes a map image of a selected geographical area and identifies RF signal sources or emitters within the area, including both stationary and mobile emitters, such as ships and other vessels. The image can include heavy signals footprint that shows the path of a vessel or vessels of interest and can identify the signals with unique icons. The screen also displays a variety of working tools, such as a “playbook,” “snapshots,” automated alerts, vessel history search data and annotation tools, as subsequently detailed. At the bottom of the screen is a panel of selectable variables for use in developing analytical criteria, such as commercial signals (X band, L band, etc.) and analytics. Real time signal analytics also are displayed, such as the number of unidentified (UID) signals via histogram & numeric count, as well as Identified signals (ID). The UID signals total number, in the FIG. 21 screen, is 32,000. The corresponding, complimentary, analyses for ID data are 3,000. These numbers are recomputed & instantly display, each time the user takes a significant action which affects the number of onscreen signals & analytics—in both the heatmap (lighter colored squares—higher density) & metadata display in the bottom panel.

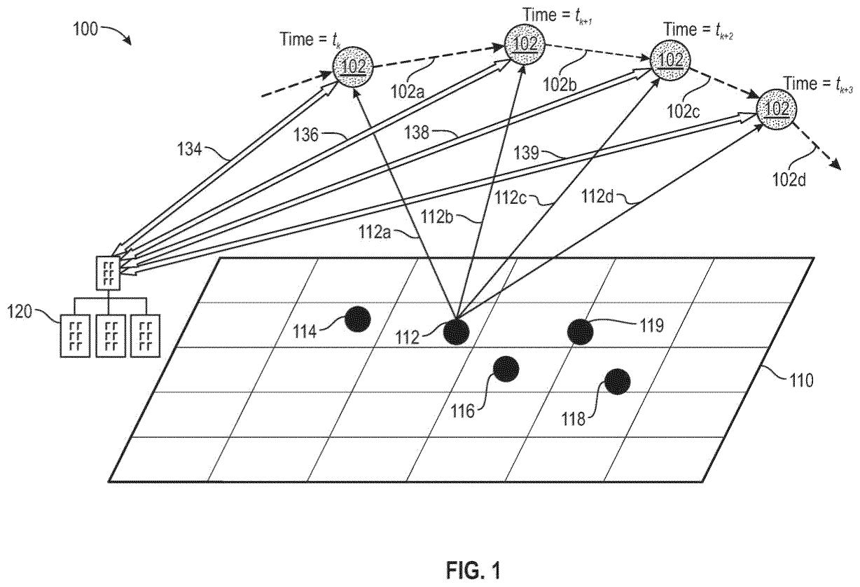

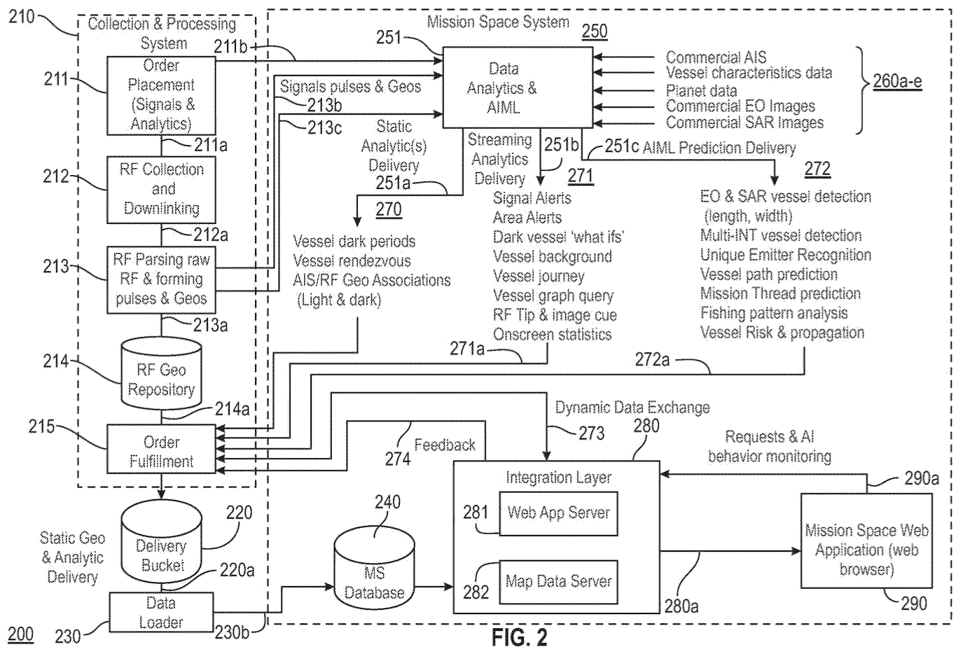

FIG. 1 illustrates an example of a satellite-based RF collection system 100 that serves as an RF data collection and data source to the mission space platform. The system 100 is for determining emitter locations, for input of RF data to one or more implementations of the mission space platform. The system 100 includes a sensing device 102, an area 110 that includes a plurality of emitters that are indicated by candidate emitter locations 112, 114, 116, 118 and 119, and a receiver station 120.

In some implementations, the sensing device 102 is a mobile apparatus, such as spacecraft, aerial vehicles, terrestrial vehicles, or some or suitable mobile platforms capable of movement along a predefined trajectory. For example, in the illustration of FIG. 1, the sensing device 102 is a satellite, in low earth orbit (LEO) or medium earth orbit (MEO) in some implementations. Alternatively, the sensing device 102 is (or installed on) an aerial vehicle such as an airplane, or unmanned aerial vehicle (UAV) such as a drone or a balloon. Sensing device 102 generally includes hardware, software and processing logic to detect and record radio signals emitted by signal emitters at emitter locations 112, 114, 116, 118, and 119. For example, the sensing device 102 is a radio signal receiver in some implementations. In general, a distance between the sensing device 102 and the emitters of area 110 varies due to movement of the sensing platform that includes the sensing device 102. The system 100 can pairwise compare delays within one emitter, the same delay within multiple emitters, or differing delays between multiple emitters. System 100 can be configured such that all or multiple pairwise copies can be evaluated using the techniques described herein for assessing data describing distances. candidates, locations, or combinations of each.

In some implementations, the area 110 is a geographic region on the Earth's surface. In some implementations, the area 110 is a region of space that is proximate to the Earth's surface. e.g., at a height of a few feet to a few tens or hundreds of feet above ground. The emitters corresponding to the candidate locations 112, 114, 116, 118 and 119 include one or more of emergency safety beacons, radars, ships or maritime vessels, television broadcast towers, wireless access points, wireless transmitters, cellular towers, cellular phones, and satellite phones, among other radio emitters. In some implementations, different emitters corresponding to the candidate locations 112, 114, 116, 118 and 119 are of different types. In other implementations, the emitters corresponding to the candidate locations 112, 114, 116, 118 and 119 are of the same type. Each emitter includes hardware, such as one or more communications radios, which transmit radio signals that can be received by other devices, such as the sensing device 102.

The sensing device 102 is mobile and includes a sensor that moves relative to the earth's surface. In some implementations, the sensor moves along a precisely known path, movement trajectory, or orbit. FIG. 1 illustrates an example of system 100 in which a sensing device 102 is moving along a defined orbit. The sensing device 102 detects signal emissions from an emitter on the ground at the various locations of area 110 during movement along an orbital path. This well-modeled or measured trajectory information facilitates the computation of how such motion path affects the time and frequency offsets of patterned emissions received during the motion.

Depending on the type of the sensing device 102, the movement of the sensing device is in space in some implementations, or on the terrestrial surface in some other implementations. In implementations where the sensing device 102 is an aerial platform, the sensing device follows one or more trajectories through space. For example, but without limitation, the sensing device can be a satellite that follows an orbital trajectory with respect to the Earth's surface.

During movement of the sensing device 102 along its trajectory, the sensing device receives radio signals from one or more emitters located at one or more of the candidate locations 112, 114, 116, 118 and 119. For example, during a known time interval, the sensing device 102 receives radio signals 112a, 112b, 112c, and 112d from an emitter at candidate location 112 at respective time intervals tk, lt 1, lt 2 and lt 3 when the sensing device 102 is at a respective location in its location 102a-102d. As shown at FIG. 1, the sensing device 102 receives radio signal 112a from the emitter at the candidate location 112 when the sensing device 102 is at a first location in its location 102a during the time interval tk and subsequently receives radio signal 112b from the emitter at the candidate location 112 when the sensing device 102 is at a second location in its location 102b during the time interval tk+1. The sensing device 102 receives radio signal 112e from the emitter at the candidate location 112 when the sensing device 102 is at a third location in its location 102e during the time interval tk+2, and subsequently receives radio signal 112d from the emitter at the candidate location 112 when the sensing device 102 is at a fourth location in its location 102d during the time interval tk+3.

In an exemplary embodiment, where the sensing devices in FIG. 1 are satellites in low Earth orbit (LEO) around the earth, the emitters may be geolocated by three collecting satellites flying in formation using blind coherent integration (BCI) techniques, as disclosed in U.S. Pat. No. 9,661,604, issued on May 23, 2017, and U.S. Pat. No. 10,466,336, issued November 11, 2019, both incorporated fully herein by reference. In addition, time and frequency difference of arrival techniques may be applied to radio waves in order to determine geolocation, as disclosed in U.S. Pat. No. 10,338,189, issued on Jul. 2, 2019 and incorporated fully herein by reference. A hierarchical satellite task scheduling system may be used to task the constellation of satellites as they are orbiting in formation, as disclosed in U.S. Pat. No. 10,474,976, issued Nov. 12, 2019 and incorporated fully herein by reference.

The sensing device 102 sends, over a communications link 134 established between the sensing device 102 and receiver station 120, the radio signals that are received at the sensing device 102 from various emitters, such as the radio signal 112a received from the emitter at the candidate location 112. Communication links can be established for exchanging data between the sensing device 102 and receive station 120 when the sensing device 102 is at a respective location along its movement trajectory.

For example, a communications link 134 is established between the sensing device 102 and the receiver station 120 at location 102a and for a corresponding time—tk, while a communications link 136 is established between the sensing device 102 and the receiver station 120 at location 102b and for a corresponding time—tk+1. Likewise, a communications link 138 is established between the sensing device 102 and the receiver station 120 at location 102e and for a corresponding time—tk+2, while a communications link 139 is established between the sensing device 102 and the receiver station 120 at location 102d and for a corresponding time—tk+3. In some implementations, the communications link 134, 136, 138, or 139 between sensing device 102 and receiver station 120 are direct radio or optical crosslinks.

FIG. 2 illustrates an example of a system 200 that utilizes the advantageous emitter identification, emitter tracking, emitter track predicting, and emitter analysis features of the mission space platform. In an exemplary embodiment, the system 200 is resident in or communicatively coupled to the receiver station 120 in FIG. 1 and is adapted to receive the raw RF data collected by sensors 102 and downloaded to the receiver station 120. In an exemplary embodiment, system 200 includes a collection and processing system 210 that is accessible by a user for an input of orders and commands for the conduct of emitter RF data collection, emitter identification, emitter tracking, emitter track predicting, and emitter analysis. The collection and processing system 210 receives as an input the downloaded RF data (signals) and analytics for further processing. The system 200 also includes a mission space platform 250 that is coupled to the collection and processing system 210 to receive the raw RF data that is relevant to the users order and commands.

The collection and processing system 210, which comprises conventional data storage and computer processing devices, is operative to receive a user's order placement, including signals and analytics. The module 211 implementing the order placement may be embodied as any conventional input arrangement, including but not limited to a directly connected keypad, touch screen or audio command device, or any remote input device, such as a smart phone coupled by blue tooth or the internet. The placed orders are delivered by link 211a to a structure 212 for identifying the scope and nature of the requested RF data collection and downlinking of the requested RF data 212. Again, the structure 212 implementing the collection and downlinking operations may be embodied as any conventional data processing arrangement. Based on the instructions from the collection and downloading structure 212, delivered by link 212a to a structure 213, the raw RF data is parsed and formed into pulses and “Geo”s (geographical location identifiers—latitude and longitude, and containment ellipse representing a very high (approximately 95%) confidence in true location of the emitter) for delivery via link 213a for storage in an RF Geo repository 214 and later delivery via link 214a to a structure 215 for fulfilling the original order.

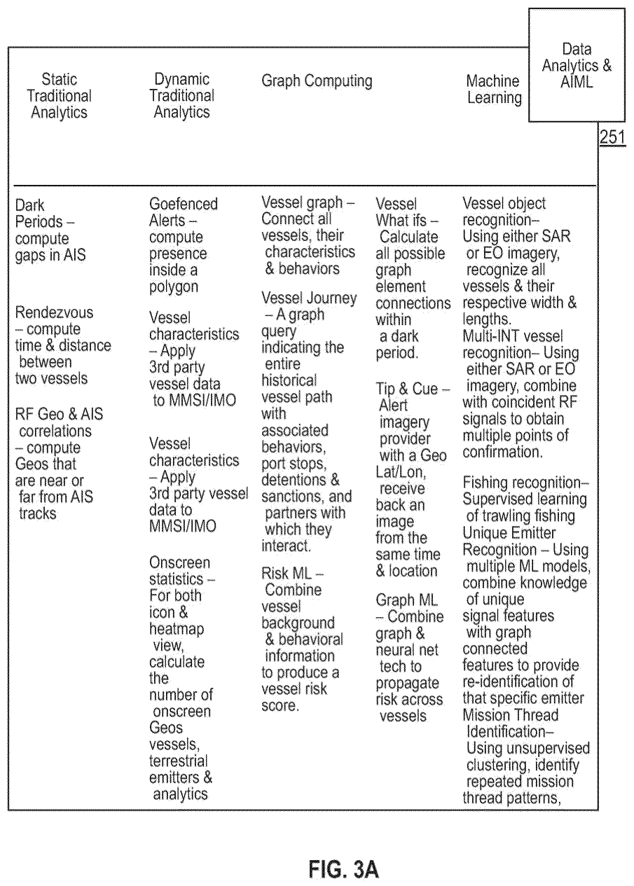

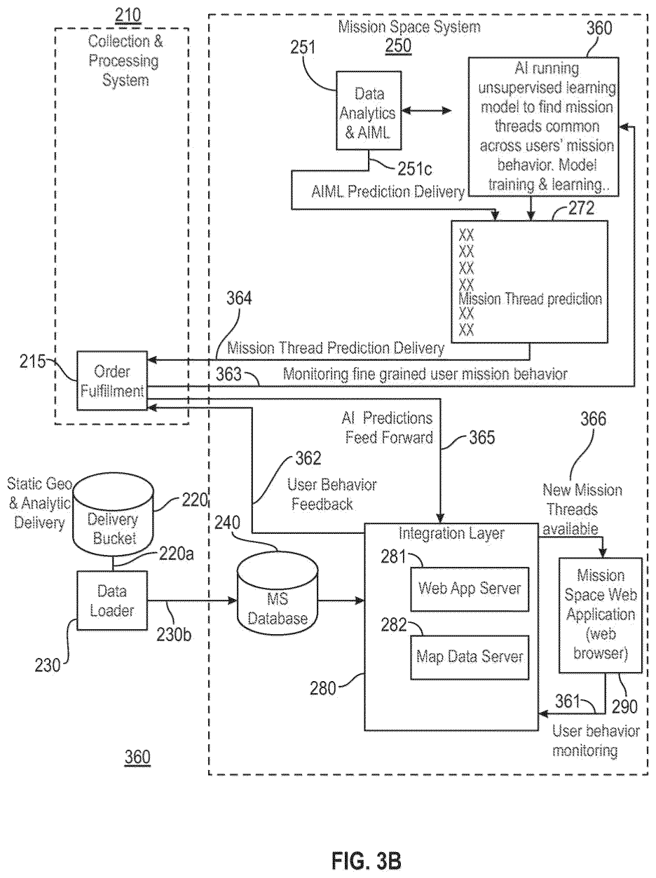

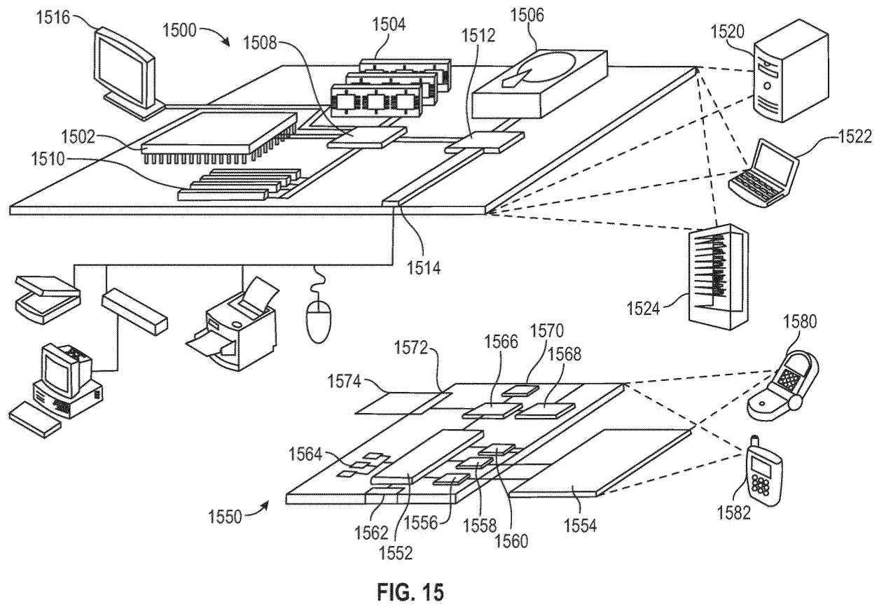

The mission space platform 250, which couples to the collection and processing system 210 with both inputs and outputs, is operative to perform the emitter RF data collection, emitter identification, emitter tracking, emitter track predicting, and emitter analysis. A data analytics and artificial intelligence/machine learning (AI/ML) module 251, preferably uses special purpose hardware, available in the cloud or as stand-alone Graphics Processing Units (GPUs) that are particularly suited for machine learning because they can handle inputs of large continuous data sets to expand and refine the performance of an algorithm. With deep-learning algorithms and neural networks, where parallel computing can support complex, multi-step processes, the more data, the better the algorithms can learn. The GPUs used in the AUML module 251 are operative to receive inputs from the collection and processing system 210, including requests for RF data and analytics from the order placement module 211 via link 211b, signals. pulses and geos from module 213 via link 213b, and via link 213c, and third party inputs 260. The processing conducted by the GPUs in the AI/ML module 251 is further detailed in FIGS. 3A and 3B. Also included but not shown are conventional data/programming storage and computer processing devices of the type illustrated in FIG. 15 that are resident in the mission space module (not AI based) and provide visual and analytical tools (herein collectively referred to as “visual and analytical tools”), such as data exploration, alerts, data tabulation, filtering, mapping and shape tools, automated shape analysis, live vessel view, subcomponents, slider features, etc. as described subsequently. The visual and analytical tools are accessed as inputs, automatically or as the user provides commands (clicking a box, drawing a lasso shape around an area of interest, click and drag slider bars, etc.) along with the datasets, and then the module 251 outputs the response from the mission space system 250. In short, these visual and analytical tools operate as non-AI modules running behind the scenes within the mission space platform.

The third party inputs 260 may be any of a number of publicly or privately available data collections (herein “external data collections”), including but not limited to commercial AIS data 260a (such as those available from Spire, see https://spire.com/maritime/ and Orbcomm), vessel characteristics data 260b (such as those available from S&P Global, see https://ihsmarkit.com/index.html and IHS Markit). commercial EO images 260c (such as those available from Maxar, see maxar.com), commercial SAR images 260d (such as those available from Airbus, see https://www.intelligence-airbusds.com/imagery/constellation/radar-constellation and ICEYE.com), and map images, such as those available from Planet (see www.planet.com). Based on the identified order for signals and analytics, input via link 211b from the order placement module 211 to the AI/ML module 251, as well as the signals, pulses and geo information input from module 213 via link 213b, the AI/ML module 251 conducts processing selectively, using the requisite third party inputs from external data collections 260a-260e and visual and analytical tools, in order to prepare a variety of analytic outputs, as requested by the user, including static analytics, streaming analytics, and predictive analysis.

As explained in detail subsequently with respect to FIG. 3A, the static analytics 270 that is delivered by the AI/ML module 251 may include, but is not limited to vessel dark period information, vessel rendezvous information and AIS/RF geo association information (displayable as light and dark features). The streaming analytics 271 that are delivered in real time may include signal alerts, area alerts, dark vessel what ifs, vessel background, vessel journey information, vessel graph query results, RF tip & cue information (where the “tip” is based on RF data alerts or user manipulation of RF data, and the “cue” is an automatic notification to a user that it is possible to allow the user to select an image provider), and onscreen statistics. The AI/ML prediction outputs 272 may include EO and SAR vessel detection (length and width via a rotating bounding box). Multi-INT vessel detection information, unique emitter recognition, vessel path or tracking prediction, mission thread prediction, fishing pattern analysis and vessel risk and propagation information. The third party inputs 260a-260e provide the added detail with regard to the emitters and their identification (ship AIS and MMSI information). the geographical environment (maps) and EO/SAR overlays of value to the users of the system 200.

The static analytics 270, the streaming analytics 271 and the AI/ML prediction outputs 272 are all fed by links 270a, 271a and 272a, respectively, to the order fulfillment module 215 in the collection and processing system 210. The order fulfillment module 215 provides via link 215a to a delivery bucket module 220 the ordered results of the mission space platform 210 processing for storage in a MS database 240 via a link 220a to a data loader 230.

The order fulfillment module 215 also engages in a dynamic data exchange with an integration layer 280 within the mission space platform 250. Data within the order fulfillment module 215 flows to the integration layer and the data within the integration layer 280 flows to the order fulfillment module 215, for delivery to a user. In addition, feedback is provided via link 274 from the integration layer 280 for suggesting to the user alternative workflows as identified by the AI behavioral monitoring 290a. The integration layer includes a web app server 281 and a map data server 282, which may be virtual or hardware having an embodiment as illustrated in FIG. 15.

The integration layer 280 may also be coupled by link 280a to a mission space web application (web browser) 290, operable by a user. The web application 290 in turn can feed back requests and behavior monitoring via link 290a. The combination of all the required inputs (213b signals and signal pulses, 3^{rd} party information 260 including vessel characteristics data and location via AIS) allows the mission space platform to identify trends across time, space and emitter phenomenology (SAR, EO, RF). The mission space AI/ML 251 is capable of ingesting data of different formats and perspectives and then fusing that information into one unified perception of the emitter. For example, imagine the mission space (MS) platform is ingesting an AIS trail of a given vessel. In addition MS AIML 251 is ingesting signals pulses and correlating those with both the accompanying AIS, related to that specific emitter, and the imagery (EO and/or SAR) of that same emitter. Once MS AL/ML 251 has correlated all data points, for a given point in time, associated with a given emitter, it can then converge upon progressive certainty as to the identity of the emitter. By fusing the various perspectives, of the same (assumed) emitter, MS AI/ML 251 can either confirm or refute the multiple assertions that these different perspectives represent the same emitter. There are a variety of emitter recognition products that come out of this emitter identification pipeline. First the AI/ML 251 can put emitter pulses together to join multiple RF perspectives to more confidently form an RF geolocation. Once the signal is geolocated, then that product can be matched up with AIS information as to the whereabouts of a given emitter. MS AI/ML 251 uses an emitter graph to test hypotheses against known signals and emitters in context (of IHS Markit data and historical AIS data). The RF*AI*Graph analysis further winnows down the possibilities as to the class and identity of the emitter, yielding an estimate of emitter class, e.g., is a Furuno radar, and the identity of the emitter, e.g., is one of these top 5 vessel candidates. The graph context allows MS AI/ML251 to further winnow down the top 5 vessel candidates to get to a ‘Top 1’ candidate or assertion that the vessel's identity is indeed known, with a given level of confidence. If necessary the MS AI/ML 251 can call out to EO & SAR imagery feeds to get further confirmatory evidence that the emitter identification is correct or incorrect. This AI/ML 251 processing pipeline is a combination of Unique Signal Recognition (USR) or re-identification of a given see of RF pulses, along with graph context (same or other emitter identifications with their locations) and other emitter imagery (EO/SAR). Ultimately the MS AI/ML 251, when combined with graph computing, yields a Multi-INT vessel identification. At that point the system generates a Unique ID to be paired up with the various emitter data points (RF, vessel background data, vessel AIS, imagery) and plugged back into the overall graph which contains progressively more accurate information about RF emitters and other emitters with which they've had interactions, e.g., rendezvous, loitering near them. following them, in port next to them, managed by the same owners, etc. This MS AV/ML pipeline 272 is denoted as ‘EO & SAR vessel detection’, ‘Multi-INT vessel detection’, and ‘Unique Emitter Recognition’.

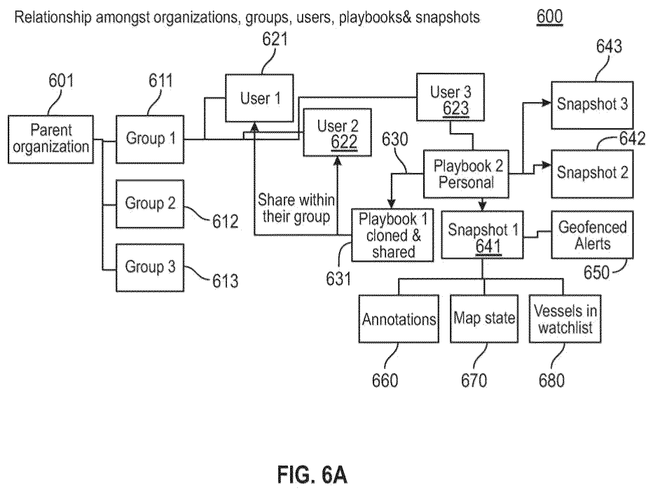

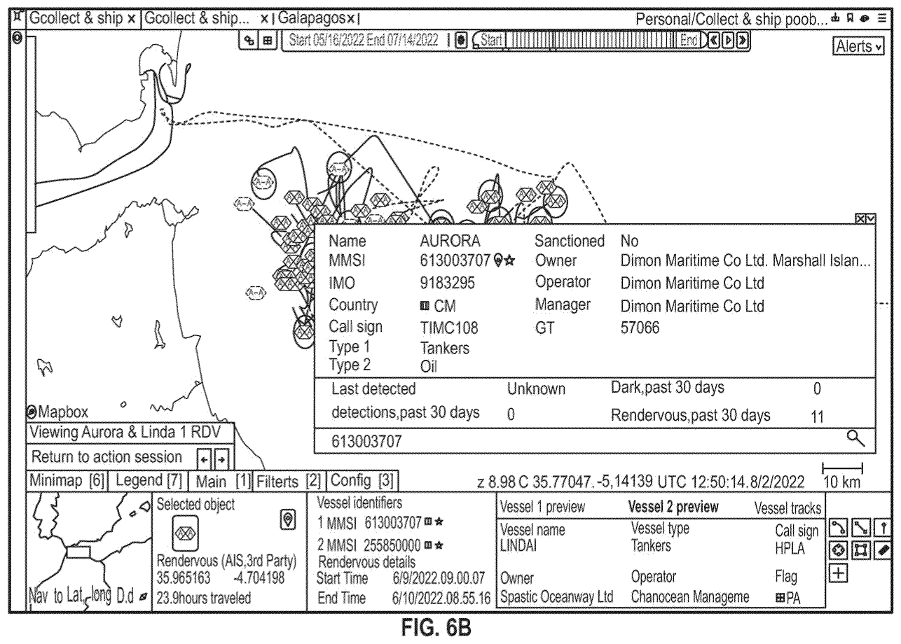

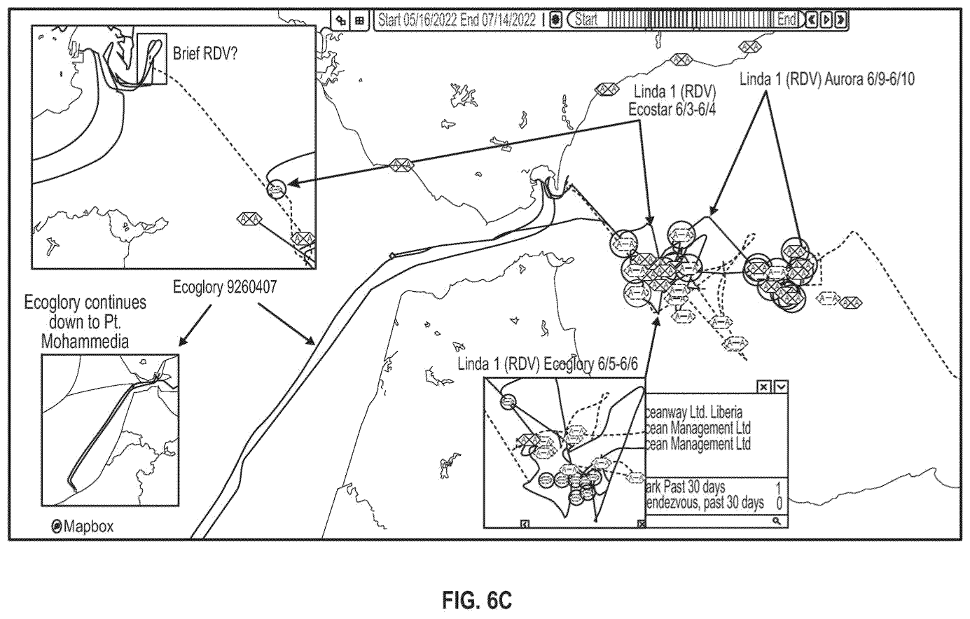

The functions of the data and analytics module 251 of the mission space platform 250, including the focus of the static traditional analyses, the dynamic traditional analyses, the graph computing and machine learning, are further detailed in FIG. 3A. The static traditional analysis may include an analysis and information output with regard to dark periods, where there is a gap in the AIS signals that have been detected from an emitter vessel. This is useful where the AIS signal source has failed or intentionally disabled or turned off or the AIS broadcast information intentionally falsified (often referred to as “spoofing”), and tracking of the emitter vessel is desired. The static traditional analysis also may include rendezvous information, where it is desired to compute the time and distance between two emitter vessels. The static traditional analysis may further include RF, Geo and AIS correlations, such as computation of Geos that are near of far from an AIS track. This is useful where the local RF environment is noisy or crowded, and potentially degrading Geo accuracies, to better calibrate Geo calculations to AIS-provided coordinates, or useful to show the opposite when the local RF environment is expected to produce high accuracy Geo calculations that do not correlate to AIS-provided coordinates can reveal events of GPS degradation (jamming) or evidence of intentional tampering with AIS broadcast information, spoofing, or dark ship behaviors. This is also useful where a user wishes to both identify and track ‘dark vessels’. Dark vessels are so named when AIS is not available. MS AIML uses multiple convergent emitter data sources such that vessels are never completely dark to our analytics, e.g., we see their radar and perhaps other imagery. Users require end to end vessel journey information in order to truly interpret their behavior. Vessels who transship smuggled goods often go dark (have non transmitting AIS) and attempt to obscure the travel of goods by performing multiple rendezvous (as shown in FIG. 6C). In this example the target vessel (AURORA)_was tracked and seen to be rendezvousing with another vessel (LINDA1). By tracking vessel₁ to vessel₂ to vessel₃ rendezvous trans-shipment of smuggled goods can be tracked. By combining various emitter data inputs the customer can track the flow of illicit goods across time, emitter, and location.

The dynamic traditional analysis performed by the data and analytics module 251 of the mission space platform 250 may include geo-fenced alerts, where an emitter vessel is found to be present within a geographically defined polygon, for example, in violation of national or international maritime restrictions. The dynamics analytics also may include an identification of emitter vessel characteristics, such that they may be correlated to MMSI and IMO databases. In order to provide further useful detail and identifiers, the dynamic analytics may add on screen statistics for both icon and heatmap views, and an ability to calculate the number of onscreen Geo-vessels, terrestrial emitters and analytics.

Graph computing, which is a computing step in the AI/ML analytics module 251 and involves the assigning of labels to data and then looking for associations of those labels, is an important element in providing a user-efficient interface for retrieving, viewing and manipulating the connected data and information. An exemplary label could be a number of ports visited in a one-month period by a certain vessel. The graph computation would compare all vessels with that frequency of port days, and may reveal that a higher-than-average port visits is indicative of AIS spoofing or sanctions violations, etc. A variety of graphs may be provided by the data and analytics module 251, including a vessel graph that connects all vessels, their characteristics and their behaviors over time and across a geographic area. The graphs also may include a vessel journey display where a graph query can produce an entire historical vessel path over time, with associated behaviors, port stops, detentions and sanctions, as well as other vessels with which they have interacted. The graph computing function can also engage risk machine learning, such that vessel background and behavioral information can be combined to produce a vessel risk score. Graph computing can provide “vessel what ifs” to show all possible graph element connections within a dark period, where there has been a loss of continuous RF data delivered from an emitter vessel of interest, as listed in FIG. 3A. Graph computing using machine learning can combine graph and neural net technologies to propagate risk across multiple vessels. There also is the “tip and cue alert” capability automatically notify a user when it is possible to allow a user to select an image provider, such as a third party input 260a-260e, identify a geo longitude and latitude, and receive back an image from the same time and location of the RF data the user is manipulating. In this way, this mission space feature is able to intuit and suggest to the user additional features and information that may be of interest, based on what the user is observing in the dynamic traditional analytics.

The machine learning feature of the data analytics module 251 offers powerful capability for vessel object recognition, using either SAR or EO imagery provided by the external resources 260a-260e, such that all vessels and their respective widths and lengths and degree of rotation can be recognized. In addition the ML provides for multi-INT vessel recognition, using either SAR or EO imagery, combined with coincident RF signals to obtain multiple points of confirmation. The ML further provides unique emitter recognition, using multiple ML models, combining knowledge of unique signal features with graph connected features to provide identification of a specific emitter. Finally, mission thread identification can be obtained, using unsupervised clustering to identify repeated mission thread patterns. These capabilities are useful to the user as they allow the user to positively identify dark vessels. Additionally, automatic mission thread identification, which auto-senses the user UX behavior and provides them with potentially useful workflows to automate the next set of steps in their mission, will dramatically reduce the workload for users who execute certain types of missions repetitively. Additionally, the mission space AI/ML algorithm “watches” what the user choses to do in mission Space with the wide variety of tools that are available, and ‘learns’ over time to suggest how the user might incorporate additional tools in their own workflow. For example, if a user takes advantage of the alert tool to create an alert every time that user comes across a potential Dark Ship, the algorithm would start to predict that and suggest alerts to the user (or even other users). Finally, the ‘user behavior modelling’ feature of mission space AI provides for a unique forward looking capability. Since mission space AI is continually tracking patterns of user activity, it can spot successful user patterns and unsuccessful, or frustrating, usage patterns. Mission space AI will use unsupervised learning to discover these trends and the advise the product manager as to which features to expand (the successful ones) and which to prune in future mission space product versions. This ability to see where future changes should be made will provide a distinct competitive advantage as the assessment of which features, to include in future mission space versions, will not have to wait for extensive usability testing. The feature recommendation and pruning will mirror the volume of usage of mission space. Furthermore, because mission space AI can compute the UX widget to UX widget traversal rates, across all users, this feature engineering via AI, can occur at a microfeature level. Given that mission space can be deployed as a cloud service, as soon as mission space AI recommends a change, to morph mission space, it can be implemented very rapidly. Users will notice frustrating aspects of their User eXperience (UX) disappear as more users struggle with the feature.

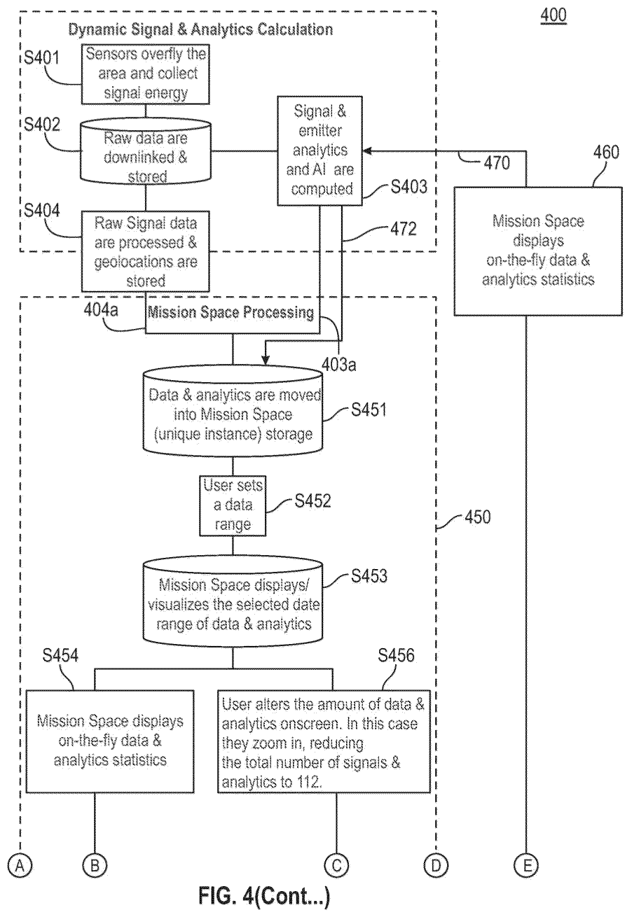

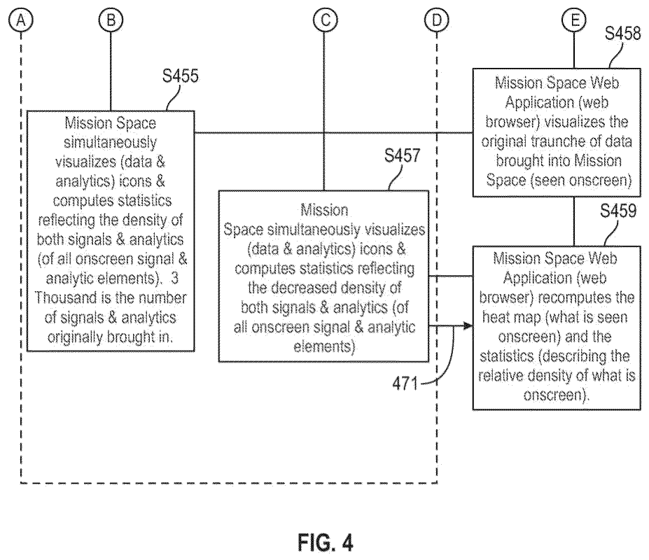

FIG. 4 is an illustration of a work flow 400 involving an application of the system 200, as illustrated in FIG. 2, and the interaction between the collection and processing system 210 and the mission space platform 250 in response to an order placement at module 211. The flow integrates a dynamic signal and analytics calculation operation 410 with the mission space platform processing 450. Within the dynamic signal and analytics calculation operation 410, as illustrated in FIG. 1, the sensors 102 overfly a geographical area of interest and collect RF signal energy in step S401. The raw data are downlinked, as the satellite passes over one of the receiving stations 120, where it is stored in step S402. Using the stored raw data, the signal and emitter analytics are computed by the AI/ML module 251 in step S403 and made available as a first output 403a of the dynamic signal and analytics calculation operation 410. A further output of step S403 is a recommended mission as determined by the AI/ML module 251, in response to monitoring feedback 470, as described subsequently. The raw signal data is also processed (parsed, formed into pulses and geos in module 213), and the geolocations are stored in step S404 and made available as a second output 404a of the dynamic signal and analytics calculation operation 410. The two outputs 403a and 404a are provided as an input to the mission space platform processing 450.

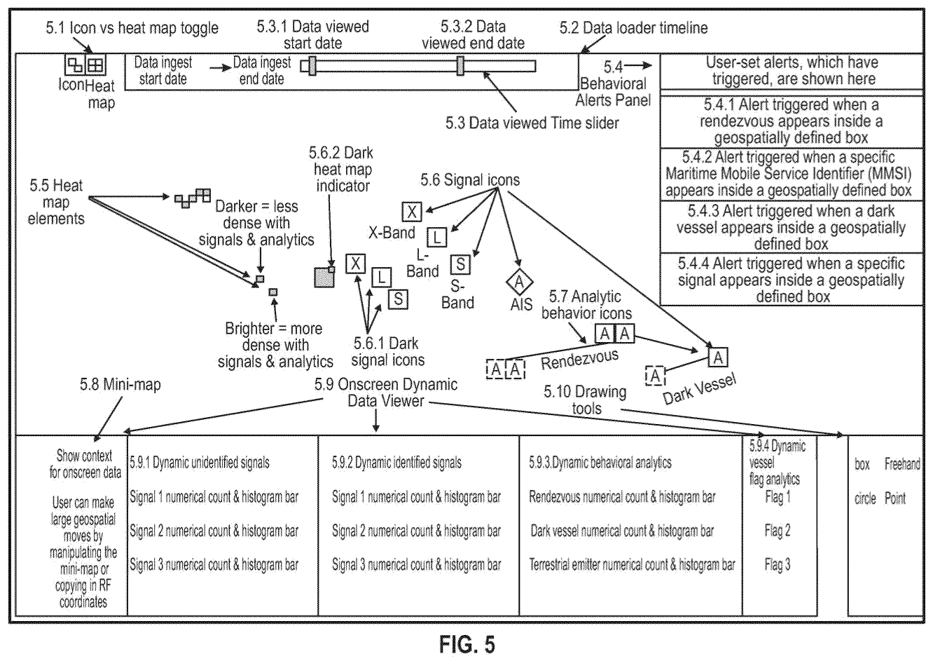

The two outputs 403a and 404a are provided as inputs to the mission space platform processing 450 and the data and analytics are moved into storage as a unique instance in step S451. In a subsequent step, a user sets a scope of data to manipulate by defining a range of dates (beginning and end), geographic area, and signals of interest in step S452. For example, such a user-defined scope may be one month of coverage over the Galapagos Islands Exclusive Economic Zone (EEZ) for L-Band satellite phones, VHF push-to-talk radios, Marine Radars, and AIS devices., shown also in FIG. 5 (5.2). The user then selects a portion of the ingested data and analytics to view onscreen by adjusting controls (e.g., 5.3.1 and 5.3.2 shown in FIG. 5 under 5.3 Data viewer time slider). The mission space platform processing then displays or otherwise visualizes the selected scope of data and analytics in step S453, using the visual and analytic tools that run behind the scenes within the mission space platform. The display may be of on-the-fly data and analytics statistics, as in step S454. The mission space platform process may take the on-the-fly data and automatically and simultaneously visualize the data and analytics, the icons and computed statistics reflecting the density of both the signals and analytics.

The an exemplary illustration of mission space onscreen elements, as laid out and labelled, are presented in FIG. 5. The following numerical references (e.g., 5.1, 5.2. 5.3) can all be found in FIG. 5. Both the 5.9 ‘onscreen dynamic data viewer’ and the ‘first order association of an object to related instances’ are driven by a new structural server-based feature that analyzes the user-selected data and object behaviors according to the context in which they appear. Mission Space includes custom software logic which analyzes all onscreen elements, moment by moment, and provides the user with three outcomes: 1. A relative density map heat (FIG. 5.5) map of all emitters (5.6) & emitter behaviors (5.7 emitter analytics) as shown in FIG. 5. An ‘Onscreen dynamic data viewer (5.9) which is a dynamic statistical calculation of the exact number of identified emitters (5.9.2), unidentified emitters (5.9.1), and emitter analytics (5.9.3), and 3. Real time updating of the heat map (5.5) or actual icons view (5.6) and statistical analyses of emitter type (5.9) and number which is dependent upon user actions. Each time the user makes a change, which affects the number and/or density of objects or object behaviors onscreen, mission space immediately performs server-based calculations and updates the visualization of emitters and emitter behaviors onscreen as well as the numerical representations, e.g., statistics (5.9) in the dynamic data viewer at the bottom of the screen, see. FIG. 5. The action a user can then take, with the updated information, is to more precisely focus in and analyze detailed emitter and emitter behavior trends, leading to insights of which the user would be otherwise unware. Other actions the user could take are to set up new alerts (5.4), create new geofences (5.10) using the onscreen drawing tools, or change the window of data they are viewing (5.2) to follow the insight. For example, in FIG. 5, the screen shows that 3,404 signals and analytics are originally brought into the displayed image.

Alternatively, the user may exercise control over the display and alter the amount of data and analytics, for example on-screen, by using a zoom in feature, reducing the total number of signals and analytics for greater fidelity and/or detail in step S456. At step S457, the mission space platform processing simultaneously visualizes (data and analytics) icons and computed statistics reflecting the decreased density of to both signals and analytics (of all onscreen signal and analytic elements). This capability saves the user from having to do numerous steps, calculating data sets, in order to understand where the signals and analytics of interest may be.

The work flow 400 further includes steps involving the mission space web application 290, as illustrated in FIG. 2. In step S458 the mission space web application (web browser) is operative to receive on-the-fly data and analytics from step S455 and automatically provide a visualization of the original tranche of data brought into the mission space platform, for example, on a screen or display. Alternatively, under user control, based on the output from step S457, the mission space web application 290 can re-compute the heat map that is seen on screen and the statistics describing the relative density of what is on screen, in step S459. In addition, the mission space platform monitors end user behavior and feeds that data back via 470 to the AI/ML 251 to compute mission thread trends in step S403. These trends are offered back via 471 to the user by the AI, feeding from step S457 to step S459, as complete, executable mission threads that match the user's apparent behaviors. The AI monitoring of user behavior is continual and uses an AI unsupervised learning model. The unsupervised model means that it just looks at trends in the user data with no input, other than user mission trends. to produce a result. Essentially it clusters ‘like mission thread paths’ together and produces, one could think of it as an average path, that is only driven by patterns in the data, e.g., users repeatedly executing a given mission with the same clicks and data entry. This is in addition to very fine grained user (UX widget use) monitoring that makes mission path prediction possible. Unsupervised modeling is to be contrasted to other supervised learning techniques, where the AI model is told explicitly when the AI is taught the answer and from that it generalized.

FIG. 3B provides an illustration of the unsupervised learning model used in the mission space platform together with user behavior monitoring and feedback. Similarly numbered modules in FIGS. 2 and 3A have the same functions as previously described. As in FIG. 2, a collection and processing system 210 is coupled to the mission space platform 250, which contains data analytics and AI/ML module 251 that produces AIML prediction delivery 272, as previously explained. The mission thread prediction is delivered via link 364 through the order fulfilment module 215 in the collection and processing system 210 to its target user 290. The mission space UX 290 order fulfillment module 215 is monitored for fine grained user mission behavior, which is fed back via link 362 to an unsupervised AI learning model 360 that is coupled to the analytics module 251, which is supervised. All deliveries must pass through the order fulfillment system 215, to ensure the customer has ordered the capability; it is simply a pass through. The mission space platform records every user behavior, whether it is in regard to signal & analytics (to include AI products) that the user has brought into mission space or their interaction with any common UX visual or analytic tool-such as time slider control, mini-map control, zooming in/out, switching from icon view to heatmap view, etc. The mission space AI is watching the ‘UX widget to UX widget’ traversal behavior, from which the system can look across all users (within an organization if that is desired) and model the antecedents to a given mission thread. On the basis of those observations, the system prepares and offers the user the proposed mission thread for execution of the entire thread, or on a step by step basis. The unsupervised AI learning model 360 finds mission threads common across user's mission behavior and automatically learns and further trains the model for enhanced performance. The order fulfillment module 215 transports AI predictions via link 365 to the integration layer 280 and in turn, the integration layer 280 provides user behavior feedback via link 362 to the order fulfilment module 215. The integration layer 280 also provides new mission threads via link 366 to the mission space web application 290, which in turn provides user behavior monitoring via link 361 to the integration layer 280.

For an organization using mission space, the platform provides an advantageous capability for a workflow that enables and enhances a user's ability to record and save analytical work product as “snapshots,” organize a collection of analytical work product as a “playbook” and collaboratively share the collection with other users in an organization. User implemented snapshots capture and lock an instant of data and displayed analytics in time and space, the content of a mission session, such as a session for a vessel search operation. Each snapshot can be saved and later accessed and replayed for interaction by a user via the mission space platform. When replayed in sequence, which is a standard mission space platform function, the snapshots demonstrate the flow of a mission analysis and the preconditions under which the analyst has determined to make a mission recommendation. Each snapshot is automatically saved as a read-only instance within a playbook, that is a dataset with user-specific additions and alterations. The playbook, as a set of snapshots, can be used to navigate through individual results of a set and have filter options applied in order to display the results in a map viewer of mission space.

An exemplary workflow 600 for an organization that utilizes the snapshot and playbook features of mission space is illustrated in FIG. 6A and an illustration of a snapshot screen shot is illustrated in FIG. 6B while FIG. 6C is an exemplary output of the process of FIG. 6A.

As illustrated in FIG. 6A, an organization 601 having multiple user groups 611, 612, 613 and subscribing to the mission space platform for a specified period of time. will be enabled to have multiple users 621, 622, 623 within a single group 611 select certain signal and/or analytics to use in connection with a mission space playbook 630. A user is a member of the organization who has subscribed to the overall mission space operation (bundled with data & analytics or a subset thereof). The organization 601 can segment users into two or more groups 611, 612, 613 to facilitate collaboration.

During the conduct of a mission, a user typically combines multiple types of data & analytics to understand what is happening in their area of responsibility. Once combined, insights are yielded & captured as individual snapshots 641, 642, 643. When shown in succession, the multiple snapshots may demonstrate the flow of the analysis that led to the overall mission recommendation. By sharing a snapshot to other users, those other users are able to manipulate but not alter a fixed scope of data to independently add diligence the originator's mission recommendation.

A given user (for example 623) may create a playbook 630 by bringing into the mission space operation, a data & analytics set (or subset) for a given time frame. Users can create as many playbooks as they like, and some playbooks may even contain identical data and analytics that they wish to analyze in different ways. Later the user may bring in more data or reduce the set of data and analytics in the playbook. Playbooks are originated by specific users, who creates the playbook, opens it up and originally sets a time frame for the ingestion of data & analytics into the playbook. Later, the user may bring in more data or reduce the set of data and analytics in the playbook. Typically, a user may make changes to a playbook contents, such as setting geofenced alerts 650, marking up insights using an annotation feature 660, changing a map state 670, and creating vessel watch lists 680. Additionally, where a user identifies an event of interest, the user can create and store a snapshot 641, 642, 643 of each event in a playbook 630, as a way to store their insights & later demonstrate them. Each snapshot 641, 642, 643 stores everything a user sees on their screen when the snapshot is created.

Again, with reference to FIG. 6A, once a user 623 establishes a playbook, only that user 623 can see the playbook, the data & analytics it contains, and any changes that user 623 may have made to them, e.g., snapshots 641, 642, 643. A user may choose to copy, or clone, the playbook 630. This will create an exact duplicate 631 that only that user can see. Often a user will take this step prior to sharing a playbook. The user 623 may keep one copy, the personal playbook, for their exclusive use and share an identical (cloned playbook 631) with other users in the group 611 (user 621 and 622) within the overall organization 601. This is referred to as a ‘shared playbook’. A user 623 also can share a playbook 630 across other groups 612, 613. Once shared, the playbook 630 and its snapshots 641, 642, 643 will be viewable and the playbook contents changeable by anyone in the organization, including the addition or deletion of snapshots. In an exemplary embodiment, once shared the playbook 630 cannot be unshared, as it belongs to the group 611.

Each snapshot 641, 642, 643 will save the state of the data & analytics onscreen, exactly as the user sees it. Each snapshot captures and locks an instant in time so that users may later retrieve and see the event exactly as they originally experienced it. When the playbook 630 that stores the snapshots 641, 642, 643 is later recalled by the user, the onscreen experience will return to exactly what the user saw when the playbook was saved. A distinctive indicator (e.g., red) may be shown on screen (FIG. (B) when the user has entered a snapshot to let them know that the data & analytics they are seeing cannot be changed. Users must execute a ‘return to active session to go back to the main playbook.

An advantage of a snapshot operation is that a user with a single click of a bookmark icon (top right), can capture an event of interest and its surrounding context. For example, with reference to the illustration of a snapshot in FIG. 6B, the event of interest is a vessel-to-vessel Rendezvous (RDV) between the AURORA (vessel baseball card, shown center screen) and the LINDAI (see vessel preview in the bottom panel). In this snapshot the user clicked on the RDV including the vessel of interest, the AURORA. Their selection may be highlighted in a first color, e.g., magenta. Mission space automatically calculates RDV relationships (RDV networking), in the same geospace, conducted by either the AURORA vessel or the LINDAI vessel (seen in a second color, e.g., purple). The AIS trail of the AURORA may be shown in a third color, e.g., light green. A ‘snapshot’ saves all the data & state of data elements and, when retrieved onscreen, shows those in a “View only” mode. In this case mission space saved the original RDV (magenta) and any associated RDVs by either vessel (AURORA or LINDA or both).

Mission space can generate multiple snapshots for a given mission session for executing RF identification. The illustration in FIG. 6C illustrated how, using the automatic RDV networking feature, an analyst can capture multiple related RDVs and include them in their mission analysis. The RDV chain shown here, involving three vessels (LINDAI, AURORA and ECOGLORY, is related to the illegal trans-shipment of goods.

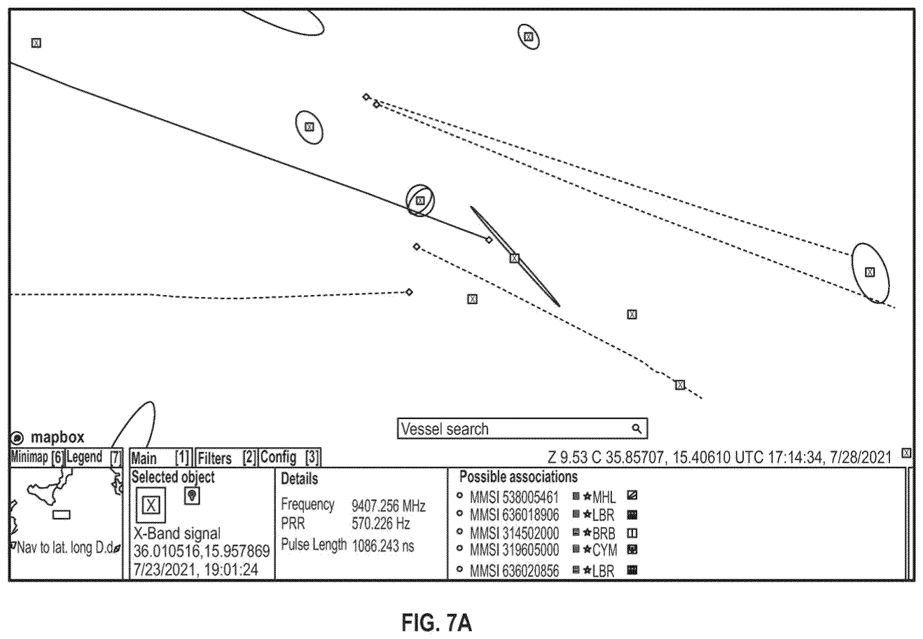

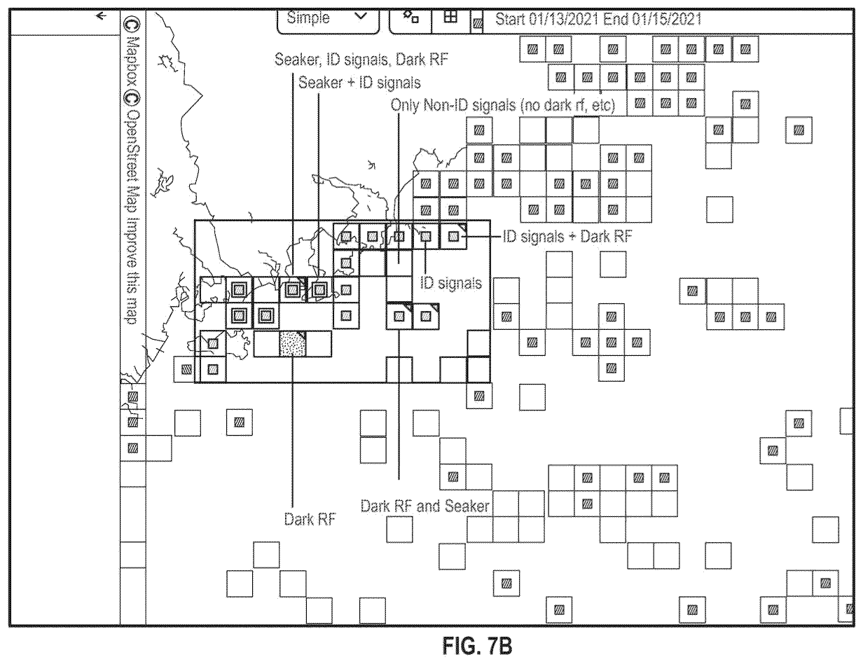

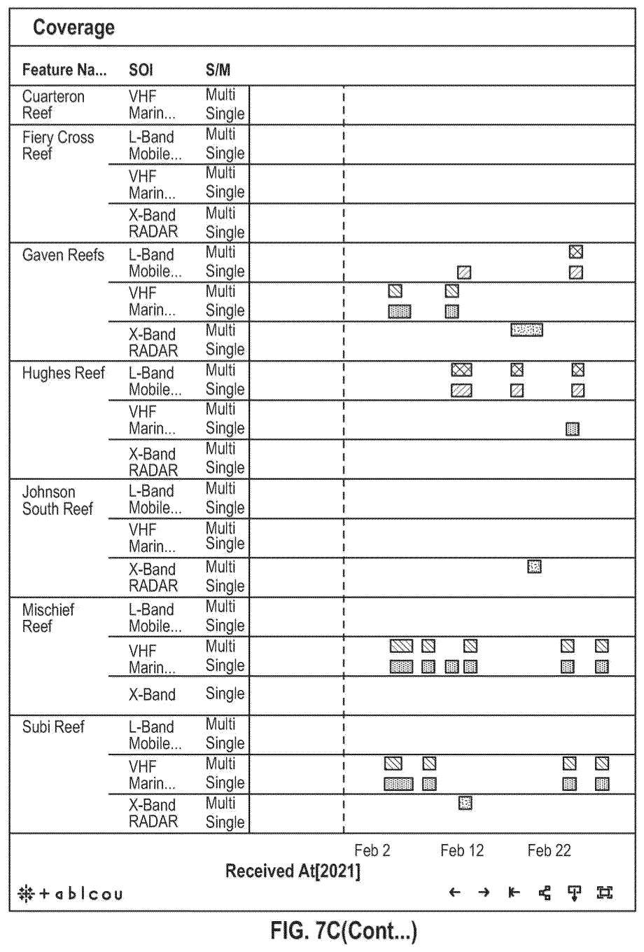

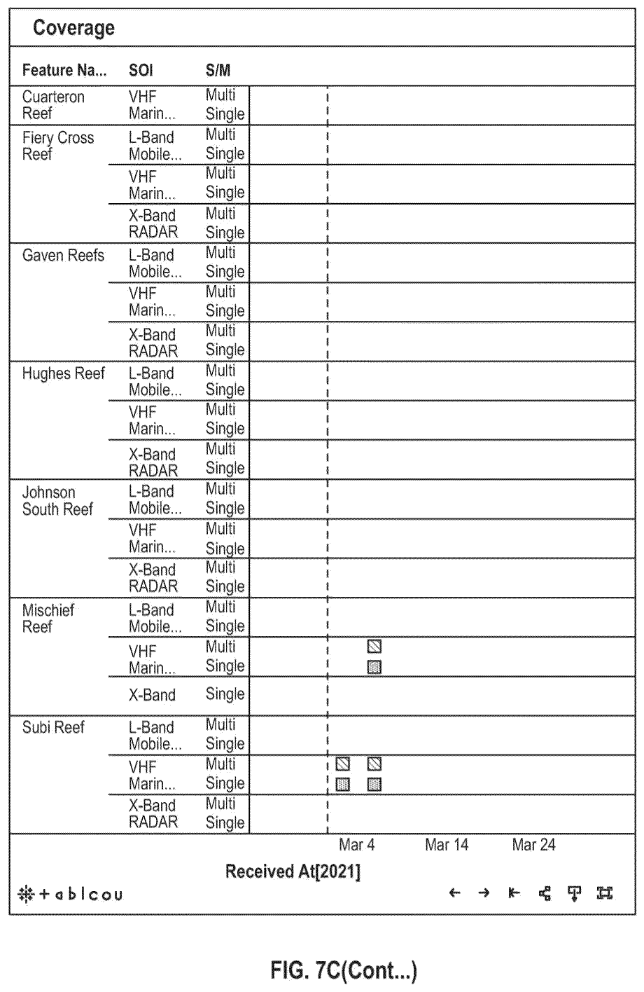

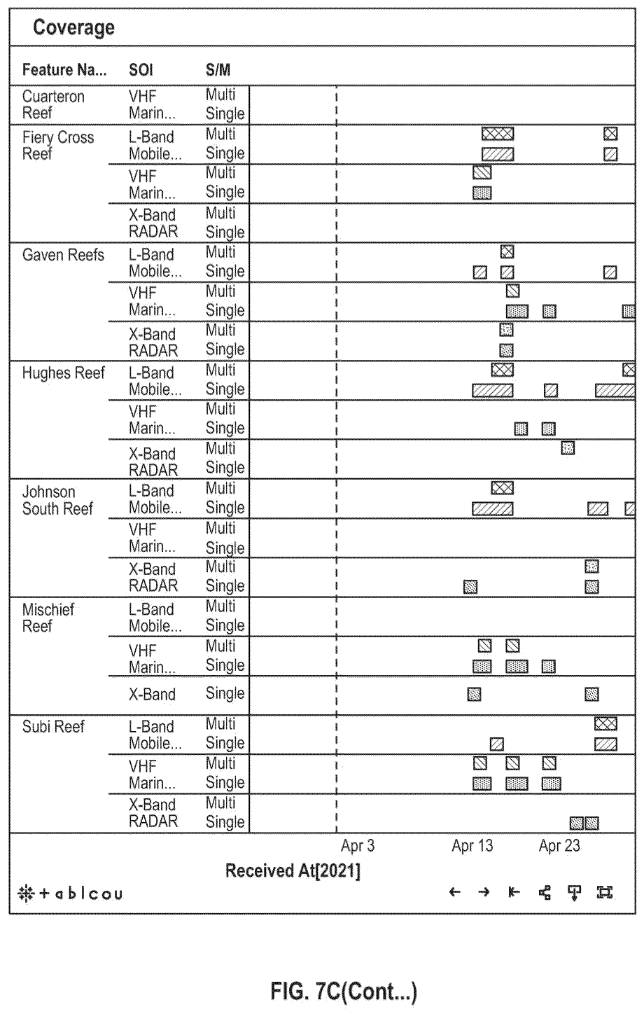

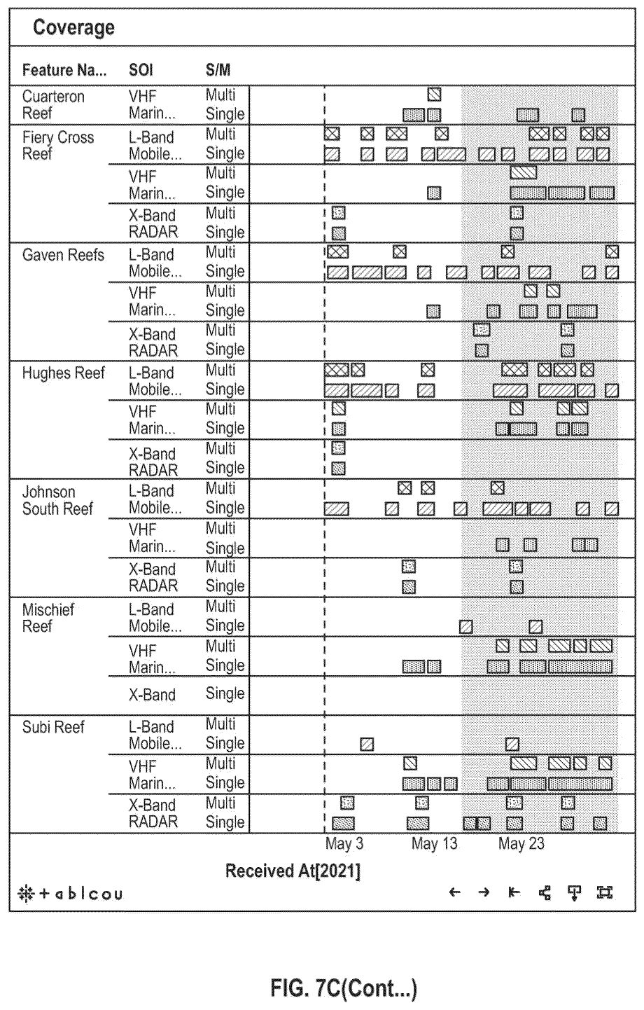

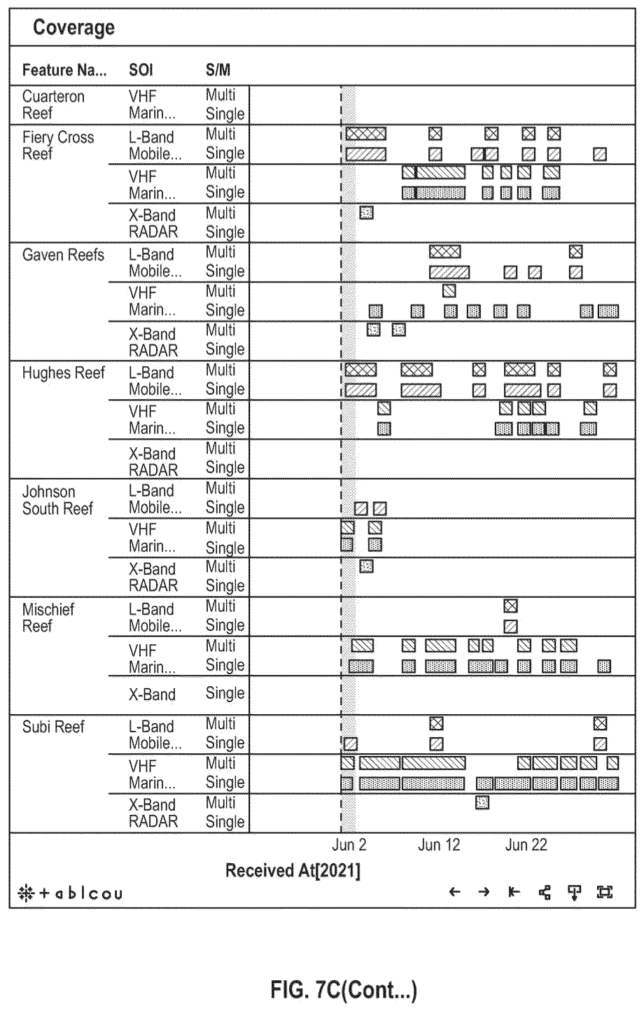

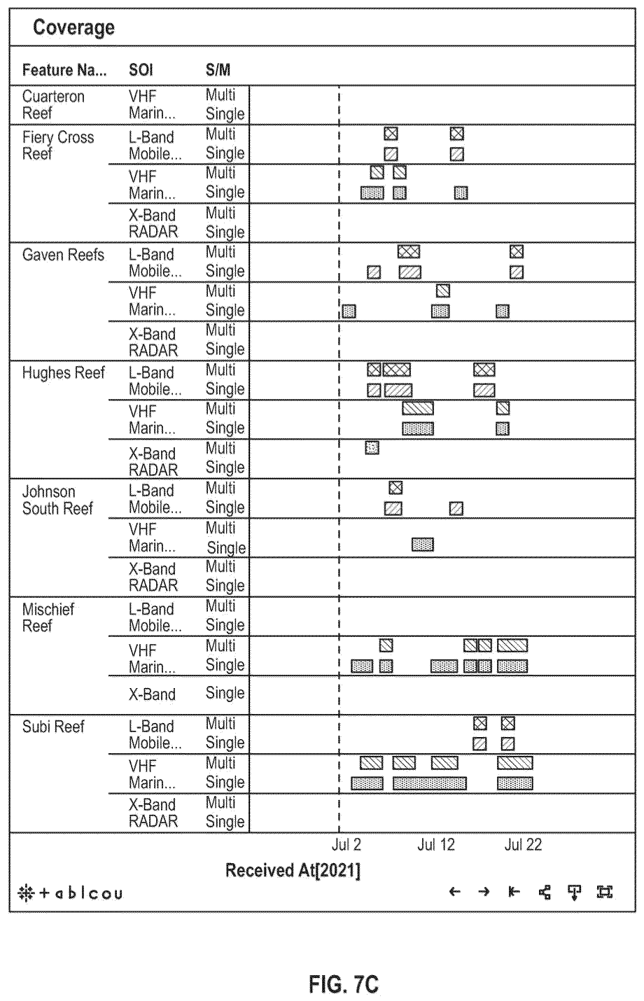

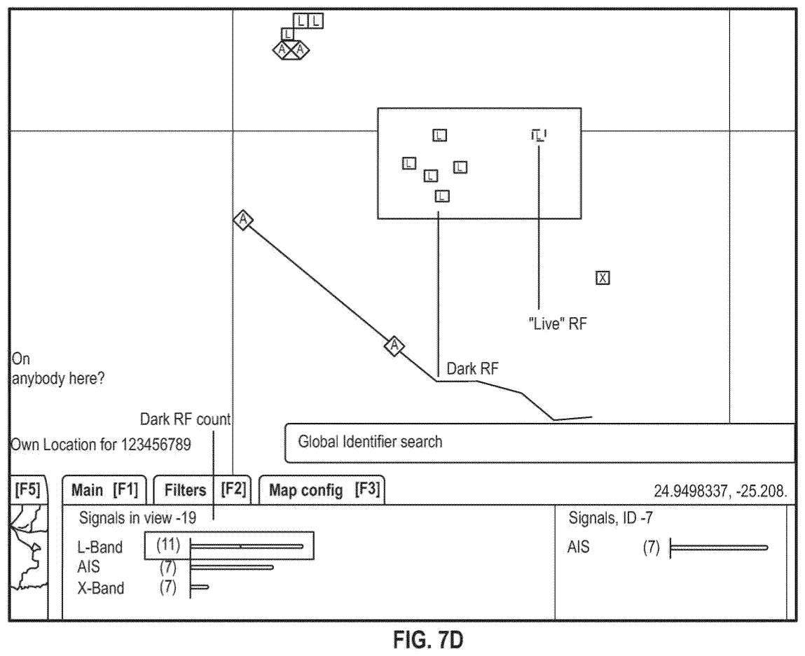

FIGS. 7A-7D illustrate example interfaces of the mission space platform for implementing automatic RF identification. The example interface of FIG. 7A provides a representative snapshot of a mission session, such as a session for a vessel search operation (described below). In this example session, an emitter that generates an RF signal is identified and details associated with the signal are conveyed via graphical outputs of the example interface. For example, the signal may be an X-Band signal having a frequency of 9407.256 MHz, a pulse per revolution of 570.226 Hz, and a pulse length of 1086.243 nanoseconds (ns). This example interface is configured to indicate one or more maritime mobile service identity (MMSI) numbers (e.g., 538005461) that have a possible association with the identified emitter. Mission space will show all possible associated AIS paths and their likelihood of matching the X-Band emission.

Each snapshot can be saved, accessed, and interacted with by a user via the mission space platform. Each snapshot is configured to as a read-only instance within a playbook (described below) that can be interacted with by the user. Mission space can also generate and store user-specific configuration data that indicates a user's client configuration preferences. When a snapshot is saved, a user's client configuration and state, e.g., map configuration, signal selection, timeframe, and map annotations are accounted for and linked to that user. When accessing a snapshot, a user can instantly access some (or all) of the saved content and configurations, even if the user elected to change the content of the playbook (outside of the context of the snapshot) Snapshots are presented regardless of later changes to the playbook data or analytics. Modules and compute logic of mission space that support a mission session allow users to save different steps of a session in a corresponding workflow so the steps do not have to be repeated by the user to achieve the same (or similar) results in a subsequent session. Additionally, snapshots can be saved & replayed in sequence to demonstrate the flow of mission analysis and the preconditions under which the analyst has determined to make a mission recommendation. And shared users can independently apply due diligence to the mission recommendations of others by manipulating the same scope of data. When the first snapshot, in a series is accessed, a control will appear on the read-only snapshot screen (a right arrow) that, when clicked will advance to the next snapshot, thus displaying that in place of the 1^{st} onscreen. In this way it is easy to walk through snapshot supported mission analysis.

Mission space leverages one or more algorithms to assign probable vessels to its own geolocation data based on associations with one or more data feeds, including third party AIS data feeds. In this way a user may be able, with high confidence, to identify a dark vessel (No AIS) via its RF Geo signal. In some implementations, a user can query an AIS dataset to identify AIS tracks for a selected vessel within a time domain selected in a map view, Mission space can include controls that allow a user to organize vessels into one or more groups and to change a color of the tracks in the map view. This function is presented as a vessel watch list that can be organized by sets of vessels, i.e., those to be watched. The colors may be changed either individually or as a group to more easily identify trends among vessels or fleets.

The AIS associations are accessible via mission space by selecting individual geolocations. Mission space is configured to generate and display a list of all the possible AIS associated vessels. Mission space can determine or compute a probability value for each associated vessel and rank the vessels based on a respective probability of each vessel. In other words, mission space can identify the most likely AIS track to pair with a given RF Geolocation, e.g., X-Band, L-Band, IIF Band, etc. Additionally, for each associated vessel, mission space is configured to determine and automatically render historical tracks of that vessel. For example, mission space can determine historical tracks of a vessel from a point in time in which the vessel was associated with a particular geolocation. In this way the user can visually inspect the outcome of mission space's AIS association algorithm. Additionally. mission space provides (not shown in the diagram) a confidence score, indicating how likely each potential vessel is to be the one that emitted the RF in question.

In some cases, a geolocation may not have an association with any known vessel activity. As indicated in the example interfaces of FIG. 7B and FIG. 7D, mission space is configured to identify these geolocations and digitally annotate or assign a “Dark RF” label to the locations. Mission space can apply a distinct visualization attribute to a geolocation that is annotated with a Dark RF label. For example, in mission space, a geolocation annotated with a Dark RF label is visualized distinctly as an insight in a heatmap, a detailed map view, or both. Additionally, mission space includes control or filter options that allow a user to filter a map view to cause the map view to display only Dark RF signals.

In some implementations, mission space includes a data exploration tool, where FIG. 7B provides an example interface of that data exploration tool. Specifically, FIG. 7B depicts an exemplary embodiment of two features of mission space, first the visualization of RF data in a manner that communicates information to the user via a graphic interface. First, seen here are various shapes and gradients of shading which communicate to the user visually whether a particular emitter; is correlated with third party datasets (Seaker), is suspected Dark RF, signal-only, etc. Second, it depicts the dynamic data tool of mission space where the subject shapes and gradients depicted will update in real time in response to user input, as mission space dynamically reformats the selected data for visualization to the user. The data exploration tool can include data tabulation features, where at least one feature allows for performing a search on available data and for visualizing trends of chosen column data. The data exploration tool allows for interacting with a user's entitled data holdings without consuming additional processing and memory resources to visualize the data holdings on a digital map of mission space. This may be described as a non-map analysis feature of the mission space platform and is discussed more below.

The data exploration tool is configured to receive one or more queries and process the queries against at least a portion of the data holdings. For example, a query may be submitted to initiate non-map analysis of a data holding. In some cases, based on the data exploration tool. a user can query, annotate, and export information across their entire entitled dataset. irrespective of a geographic region of the world or time that the data was collected. The data exploration tool can generate a set of results following completion of an example non-map analysis operation, e.g., to process a query.

Mission space can detect user selection of some (or all) of the results and subsequently generate a new or existing playbook for storing, accessing, and interacting with the search results, for example, with user-specific additions & alterations made to it as e.g., snapshots. The playbook can be used to navigate through individual results of the set and to apply one or more filter options for viewing the results in a map viewer of mission space. Additionally, mission space can generate one or more new alert rules that are centered on a particular search result(s). The alert rule(s) may be generated based on user input, automatically using control logic of mission space, or both. For example, a new alert rule can be configured to notify a user of similar/same results as new data becomes available within the playbook application.

The example interface of FIG. 7C corresponds to a data tabulation feature the data exploration tool. The interface of FIG. 7C provides an example view of a Tableau visualization feature of the data exploration tool, which generally shows specific signals that have appeared including when (e.g., a time value) the signals were initially detected. In some implementations, the example view can include common visualizations as shown at FIG. 7C, whereas in some other implementations a view can include uncommon visualizations as well as a mix of common and uncommon visualizations. In the example of FIG. 7C, a shading or particular pattern of a square can represent a specific portion of a visualization that a user has selected. For its map view, mission space is configured to apply one or more filters to the visualization data and generate a geospatial view of the data based on the applied filters. The filters can include at least time-based filter or a metadata filter.

As described herein, mission space is capable of filtering on different characteristics of a set of geolocation data and insights about the data. In some implementations, mission space includes a range of variables and provides for multi-selection of different variables to allow for using, or filtering on, different metadata attributes. For example, a user (or the system) can choose a range or multi-select variables for different metadata attributes. Once selected, a map view is generated to re-render and adjust a mapping output based on the selection inputs. In some implementations, a user can select to show only signals that were detected within a frequency range of 157 MHz to 161 MHz. This feature will be useful to mission analysts as their task often involves narrowing their search, based on prior findings, to narrow down to a smaller set of target emitters.

Additionally, mission space can generate one or more advanced filters across one or more connected datasets. The advanced filters can be generated based on user input, automatically using control logic of mission space, or both. An example of an advanced filter can be “only show Xband Navigation Radar signals within range 9410.1 MHz-9410.2 MHz that are associated with Ecuadorian vessels.” In some implementations, the advanced filters are generated using predefined conditional logic structures that define one or more constraints, such as signal type signal band, frequency range, vessel type, geographic location, metadata type, etc. In some other implementations, the advanced filters are generated using intelligent filter logic that dynamically generate filters from natural language queries submitted by a user.

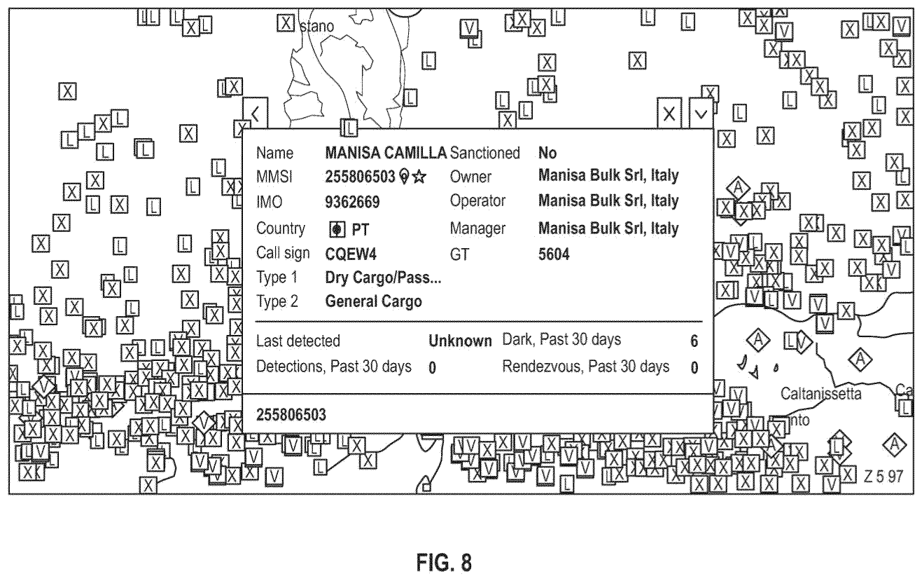

FIG. 8 illustrates an example interface of the mission space platform for implementing a vessel search. The mission space vessel search enables users to search for vessel information across one or more vessel registries, such as proprietary registries, third-party registries, or both (Shown in FIG. 8 and referred to as a vessel baseball card). For each identified vessel, the vessel search can generate detailed information about the vessel, including a name or MMSI of the vessel. An identified vessel can be added directly to a vessel watch list for further monitoring. The vessel watch list automatically notifies users when mission space detects new instances of geolocating the target vessel. The vessel search feature can allow a user to navigate directly to a vessel's last known location. In some implementations, a vessel watch list of mission space is an information repository that includes data describing vessels of interest within a specified playbook. Vessels can be added with a single click, inside the vessel baseball card on the ‘star’ icon. Additionally, a user can access vessel registry information about a given vessel as well as navigate, or direct a map view, to a last seen location of the vessel.

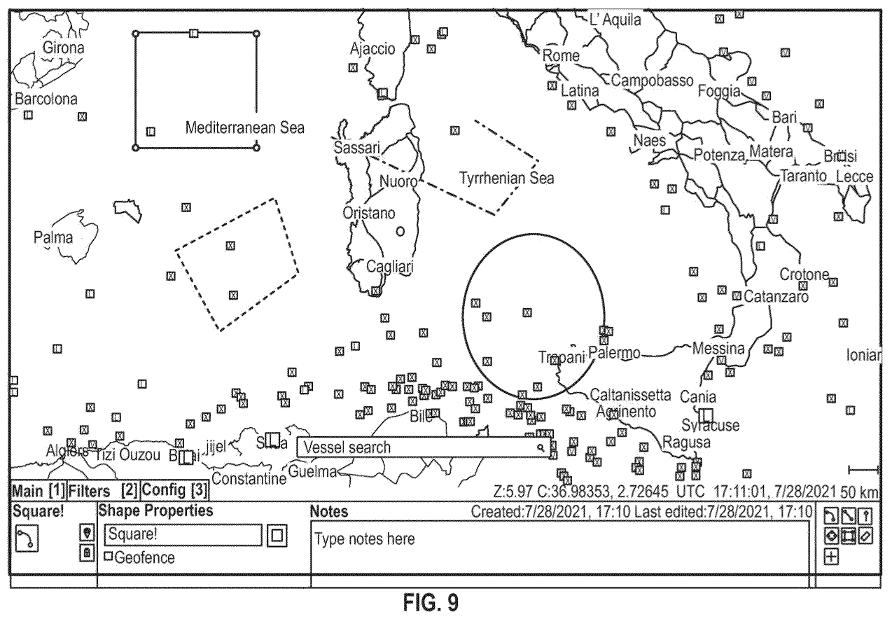

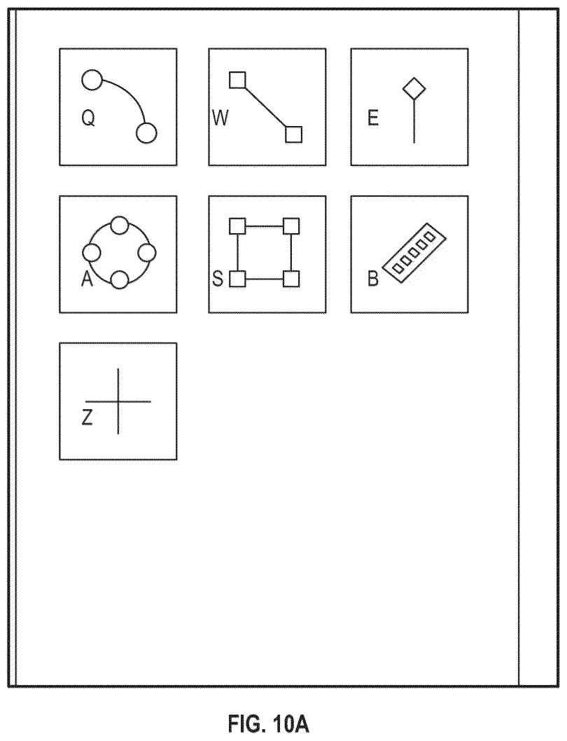

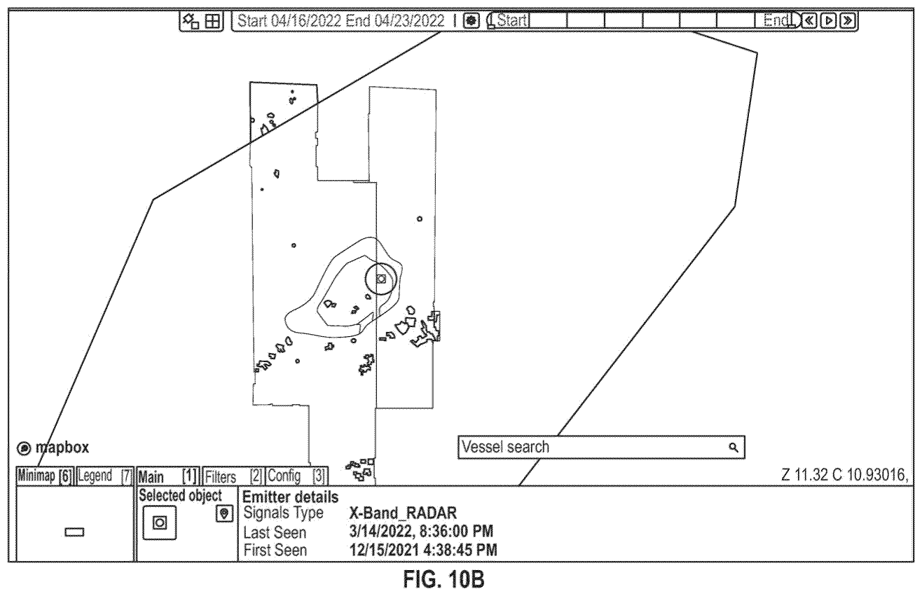

FIG. 9 illustrates a first example interface for mapping tools of the mission space platform. FIG. 10 illustrates a detailed screenshot example for mapping tools of the mission space platform (see FIG. 5, item 5.10). Mission space can include a suite of mapping or shape tools that enable a user to draw polygons, circles, squares, lines, and points onto a generated map. Additionally, the map tools allow users to annotate items of interest, to point out to their user partners. Mission space is configured to perform automated analysis on any shape drawn on an example map. Based on a combination of control logic and user input, mission space can select from multiple options depending on a type of analysis being performing.

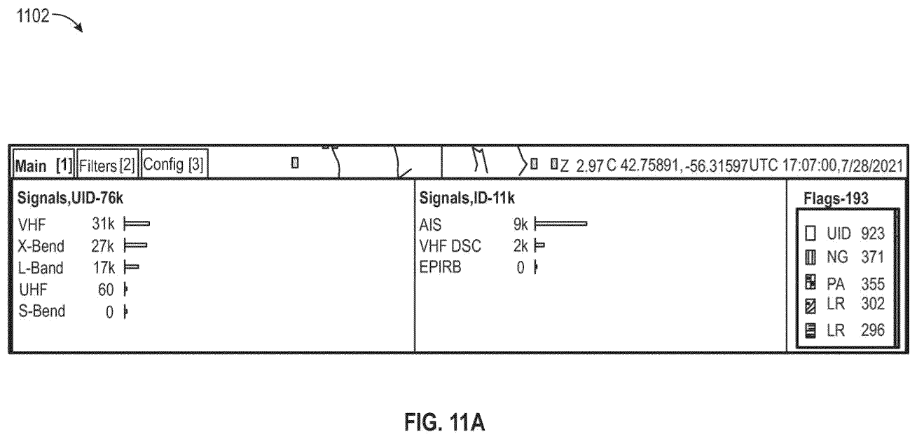

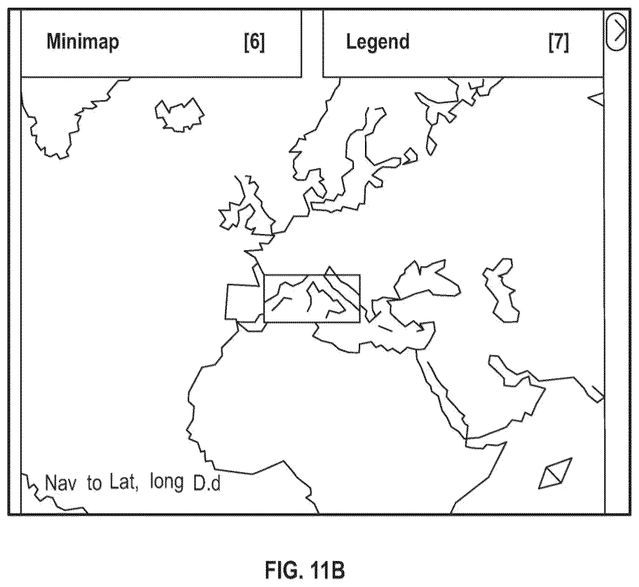

For example, mission space can include an area of interest (AOI) analysis tool that is operable to perform RF analysis on a region identified by the shape tool and generate a summary or breakdown of the RF data present in the designated area. The summary can include counts of signals, metadata distribution charts, flags of known vessels in the area, and historical activity associated with the area. Counts of signals are also discussed below with reference to FIG. 11A. The tool can also perform maritime analysis. The maritime analysis includes loading reported AIS emissions in a given area for a set amount of time as well as determining counts and distribution of the types of vessels in the area for the specified time.

Mission space can include a live vessel view feature. For example, live vessel view can include an input control (e.g., button) for adjusting a time domain of mission space to the current time. In some implementations, the map view is configured to display the most recent locations for all vessels broadcasting AIS information worldwide. Mission space can conduct a search of any vessel that has broadcasted signals bursts within 7 days. A user can use the vessel search in this view to find and highlight a vessel of interest.

Referring again to shapes associated with the mapping tool, the shapes can be used to annotate, or take note of, one or more items on the map. The shapes can be utilized with an alert system of mission space via one or more rules or triggers of the alert system. For example, the system can be an alert module that encodes a rule for automatically detecting signals within a shape. The alert module can iteratively scan a map, identify a shape generated via the map tool, and trigger the rule to automatically detect for the presence of RF/emitter signals within the shape. Additionally, the mapping tools enable a user to measure distances and copy specific coordinates on the map. These coordinates can be copied into the mini-map feature, as illustrated in FIG. 5, item 5.8.

In some implementations, the alert module enables users to create alert rules involving RF data and analytics for designated areas of interest. Each rule can have a criteria or threshold condition that triggers an action when the criteria or threshold condition is satisfied. For example, when criteria for an alert rule is satisfied, the alert module can generate an in-app notification (e.g., an alert) to a user. In some implementations, the alert is presented to the user in an alert panel of a mission space application, and a new map icon is generated indicating where and when the alert was triggered. Additionally, the user has the option to receive these alert notifications via email, text messaging, or like kind. When creating an alert rule in mission space, a user can select an option or configure the rule such that the system triggers a request for an additional source of information when the alert triggers in response to criteria of the rule being satisfied. The additional sources of information can include one or more Electro Optical (EO) and Synthetic Aperture Radar (SAR) images, or an open source collection. The rule and additional sources may be associated with a tip & cue feature of mission space. Mission space can perform imagery ingestion using data received or obtained from an example provider account. For example, mission space can establish a communication link with the account to receive data associated with the account.

In some implementations, a user can link an existing EO/SAR provider account to an example mission space application to import EO/SAR images and directly overlay the images on a mission space map. In some other implementations, mission space includes a web map server (WMS) import function that allows a user to add one or more layers of a WMS directly onto the mission space map. For example, mission space can establish a communication link with the WMS, where the link enables a user to obtain and toggle a dataset (e.g., an external dataset) hosted at the WMS.

FIG. 10B illustrates a working API-to-API call in which Mission Space called the EO imagery provider. In this view a stationary emitter's location was sent to the EO provider who responded with three image strips closely related to the located of the emitter on this reef (marked with a circle). In this picture a stationary emitter is observed in close vicinity of a reef, indicating potential use of the reef for illicit activity. The EO image alone would not suggest human activity, and the RF geolocation alone would not disclose the presence of a reef, however, the mission space platform can connect the two datasets and provide the user with a valuable image and information, e.g., this reef likely houses stealth detecting radar.

FIG. 11A illustrates exemplary interfaces of the mission space platform that relate to dynamic data statistics and mini-map features. Regarding dynamic data statistics, mission space includes a “Main” tab 1102 that summarizes signals and insights displayed on a map view. The summarized signals and insights can include signal counts (for identified and unidentified signals), insight counts, and a respective country flag(s) of an associated vessel and its corresponding emitter. Mission space is configured to dynamically adjust a summary of the data as a user changes the map view, alters a time range associated with the map view, selects different filters, or combination of these. A user can change a map view by modifying a pan, a zoom, or both. These data are recomputed in real time & shown at the bottom of the map as user adjustments are made.

Regarding mini-map, mission space is configured to generate a mini-map 1104 that is a smaller version of an application map view (e.g., a larger map view visual), as illustrated in FIG. 11B. The mini-map 1104 can be used to ease navigation and orient a user to a particular section of the world that a current map view session is presently visualizing. The user can click and drag the mini-map and an application map view to which the mini-map corresponds will adjust simultaneously with the movement of the mini-map 1104. For example, the white rectangle can be clicked and dragged and in real-time the summary of signals shown in FIG. 11A will update as the rectangle is moved—thus allowing the user to dynamically summarize the whole of the minimap or portions of it. In some implementations, the mini-map 1104 includes input data fields for receiving one or more user inputs. For example, a user can manually input, using the data fields, a latitude value and longitude value via text entry at the data fields to navigate directly to a specific geographic location. Additionally, under the tools section, shown below. the user can use the “+” tool to save the latitude and longitude (lat/lon) and copy that into the mini-map to be moved to that location, i.e., the onscreen map is centered on the lat/lon as soon as the user copies the lat/lon & pastes it into the bottom of the mini-map.

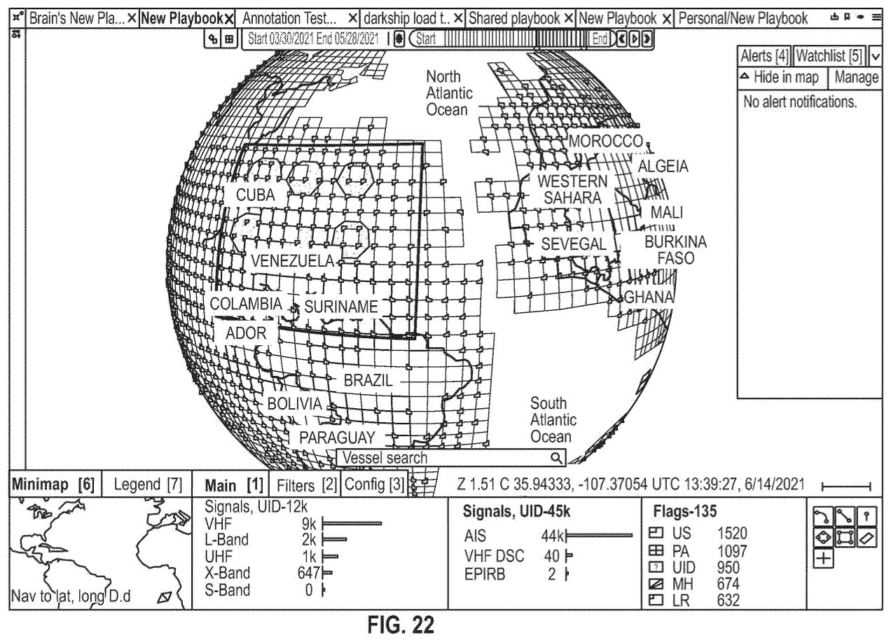

Mission space is configured to include a map-type input selection, such as a first toggle button, to switch from a two-dimensional (2D) Mercator map view to a three-dimensional (3D) Globe map view, as illustrated in FIG. 22. Using the 3D Globe map view, a user can navigate the globe view by using click and drag input controls of the viewer, which allow for spinning the globe to a desired location. In some implementations, the globe view includes a “true north” input control (or button) that allows a user to re-orient the globe so that the North Pole is on top. Mission space can also include another map-type input selection, such as a second toggle button, to switch from a “simple” signals view to a “detailed” signals view. The data output via the detailed signals view includes detailed symbology option that provide more in-depth distinctions between the different types of signals. This can enable some users (e.g., advanced users) to quickly characterize the type of activity that is occurring in a given area.

FIG. 11B shows the heat map view and demonstrates that both signals & analytics are summed together to create the density shown via the heat map. For ease of use, where there is an analytic(s), contained in the heat map square, a color indication (within the square) shows that it also contains an analytic. In this case purple indicates that the heat map square contains at least one stationary emitter. Dark ships & RDV analytics are shown via an orange indictor & Identified MMSIs are shown via a green indicator.

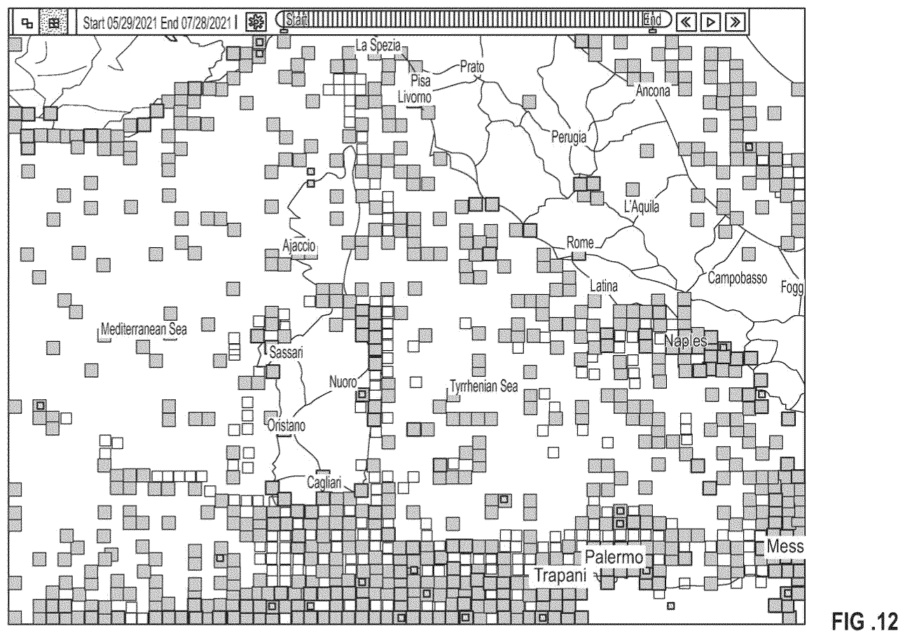

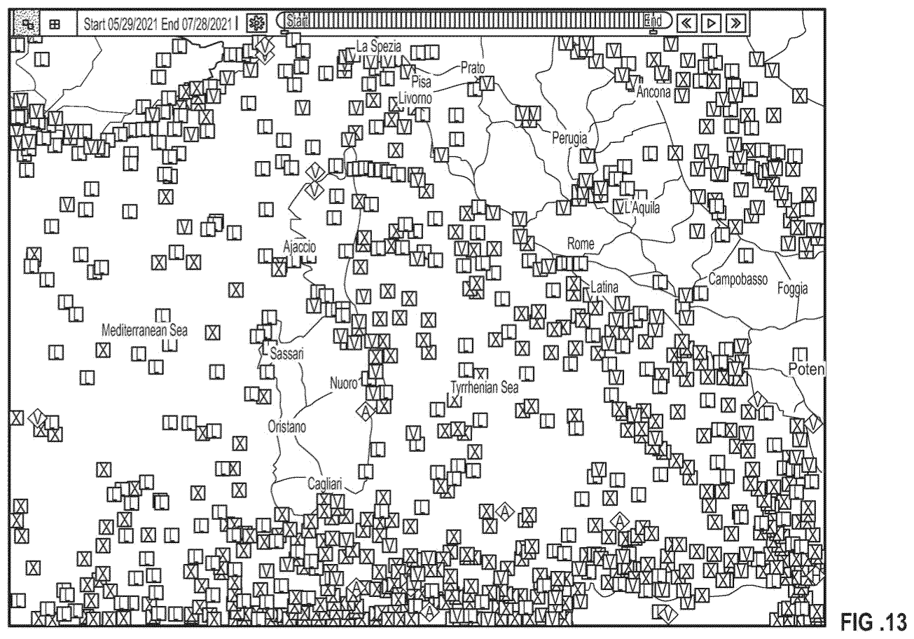

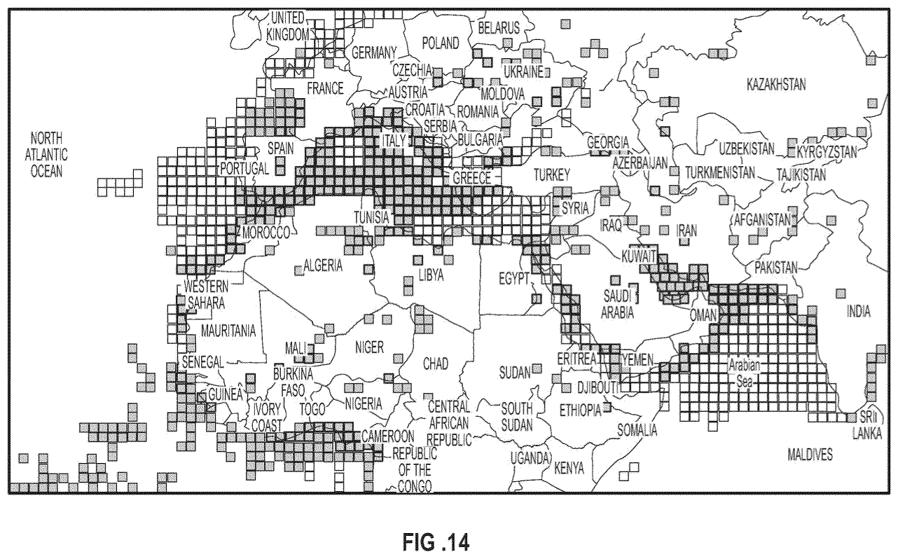

FIG. 12 illustrates a first example interface for a heat-map feature of the mission space platform. FIG. 13 illustrates a second example interface for a heat-map feature of the mission space platform. FIG. 14 illustrates a third example interface for a heat-map feature of the mission space platform. In general, the mission space heatmaps are configured to visualize a broad view of RF data and insights collected by the sensing devices of system 100 in FIG. 1. Each of the example heatmaps of FIGS. 12, 13, and 14 differ from traditional heatmaps generated by conventional systems for signal analysis.

For example, each of these example heatmaps can be broken down into different elements and generated on a grid system, where each grid of the grid system is selectable. A grid is described alternatively as a grid point. When a user selects a grid (or multiple grids), mission space detects the user's selection input and generates emitter/RF signal statistics that are shown on the summary (or map) view. Mission space can automatically, and iteratively, update sets of statistics of the summary view for a given heatmap. In some implementations, mission space can streamline or reduce its overall utilization of processing and memory resources of its system by updating signal statistics for only those grid points identified by a user's selection input.

Mission space can include control logic that causes a given heatmap to be dynamically adjusted, at least by re-rendering its visual/graphical outputs. The heatmap may be dynamically adjusted and re-rendered by the control logic, by user input, or both. In some cases, a heatmap is re-rendered in response to an adjustment that is made to an area, time domain, or data in a corresponding summary or map view. Additionally, the control logic or user can customize a heatmap, for example, by adjusting a luminosity (e.g., from 0-100%) of identified and unidentified elements based on the user's visual preference. The control logic embedded in mission space will select by default (absent user input) the optimal visualization for a particular heatmap by adjusting color tones, shading, transparency, luminosity, sub-component shape, and other visual features of the interactive heatmap.

Each grid of a heatmap can include can include one or more sub-components. In one case, a heatmap includes three sub-components, whereas in other cases, a heatmap can include more or fewer sub-components. A set of sub-components can include: i) a fill color of a square corresponding to the grid; ii) an outline color of the square: and hi) a badge visualization. In some implementations, each grid of a heatmap is a square, whereas in some other implementations, grids of a heatmap may be another shape or polygon, such as a pentagon or hexagon. The fill color represents counts of RF emissions collected by sensing devices of system 100. The fill color can be dynamically re-calculated by control logic of the visual and analytical tools (e.g., automatically), based on user input, or both. In some implementations, the fill color is dynamically re-calculated in response to detecting a user input for applying one or more filter options to the heatmap, such as a time filter or a signal type filter.

The outline color represents a maximum potential of signals in an area. This sub-component indicates why a heatmap may include a potential “blank” spot. For example, a completely blank spot on a heatmap means there is no data (or potential for data) being associated with that grid point irrespective of the filter options, whereas a spot with an outlined, empty square means one or more filter options is causing the blank spot. A respective badge visualization of each grid conveys information about that grid. For example, if an area corresponding to grid has an identifiable signal, behavioral insight, and/or other attributes, then a badge visualization may be placed on top of the grid to indicate a special event occurring in that area.

As illustrated in FIG. 11C, unique feature of the heat map is that, when a user's view contains data or analytics which they have not selected, the heat map will contain ‘empty squares’ tipping the user to explore more, by expanding the time slider or selecting more data or analytics. This and the purple indicators are unique designs of Mission Space meant to lead the user to insights they may have overlooked.

Mission space includes a heatmap override feature that is operable to switch a map view from a heatmap visualization to a detailed visualization that shows individual RF geolocations and insights (see FIG. 5, item 5.1). In some implementations, the transition occurs automatically when the user zooms in, for example, past a zoom level of 10 (city view or closer). In some other implementations, the transition occurs if a user manually selects an override button, for example, between zoom levels 5.8 and 10. Other zoom levels for manual transitions and zoom in thresholds for automatic transitions, can be used.

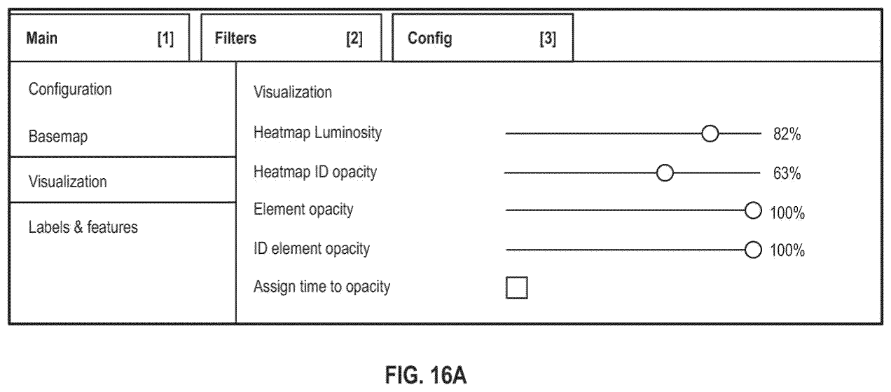

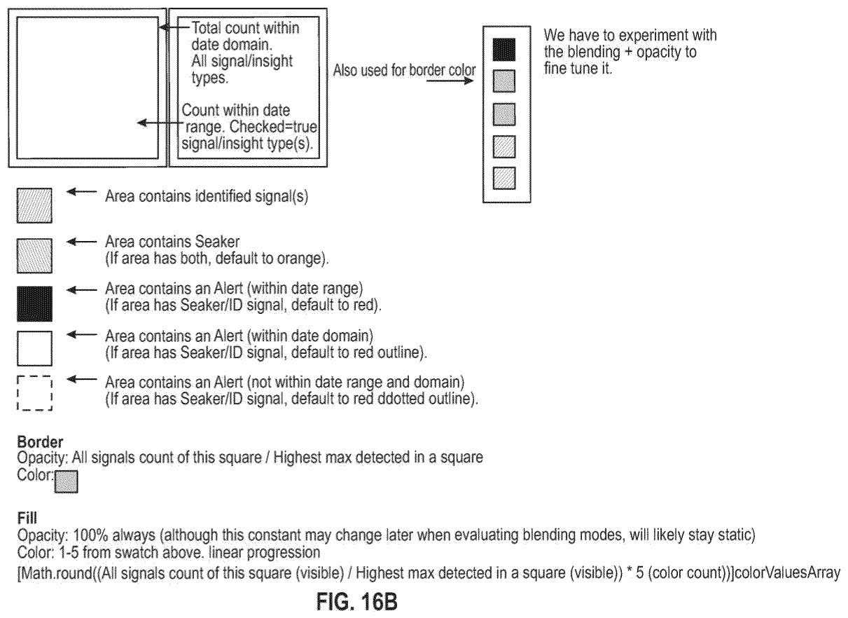

FIG. 16A illustrates an example configuration interface for a heat-map feature of the mission space platform. For example, the configuration interface can include user selectable inputs for adjusting a heatmap luminosity (e.g., from 0-100%) of an identified and unidentified element based on the user's visual preference, as described above. In some implementations, a configuration interface of mission space can be used to adjust different attributes of a basemap, visualization, or labeling feature of a heatmap or map view. FIG. 10B illustrates example settings and features of a grid point in a map (or heatmap) generated by the mission space platform. The information conveyed at FIG. 16B applies to the one or more sub-components described above with reference grid points of a heatmap.

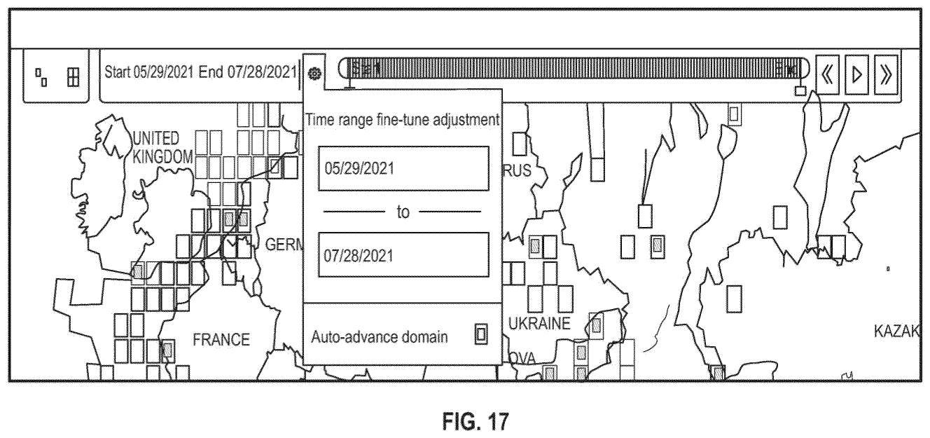

FIG. 17 illustrates an example interface for a time-slider feature of the mission space platform. The time slider is a control mechanism that allows the user to load data within a specific time extent. Additionally, the time slider mechanism has a slider bar to further filter and navigate the data within the specified time extent. The slider bar can be adjusted by manually dragging the start/end, utilizing the navigation buttons, or inputting the dates via a calendar input. In some implementations, a user may specify a time-range with a “start” date and an “end” date and the time slider can be used to perform fine-tune adjustment of the specified time range. Mission space includes an auto-advance time domain function. Auto-advance ensures that each time the user re-enter mission space they see the most current data received into the mission space database (from the ordering system). Otherwise the user would be returned their ‘leaving context’. Mission space would normally return the user to their last work context.

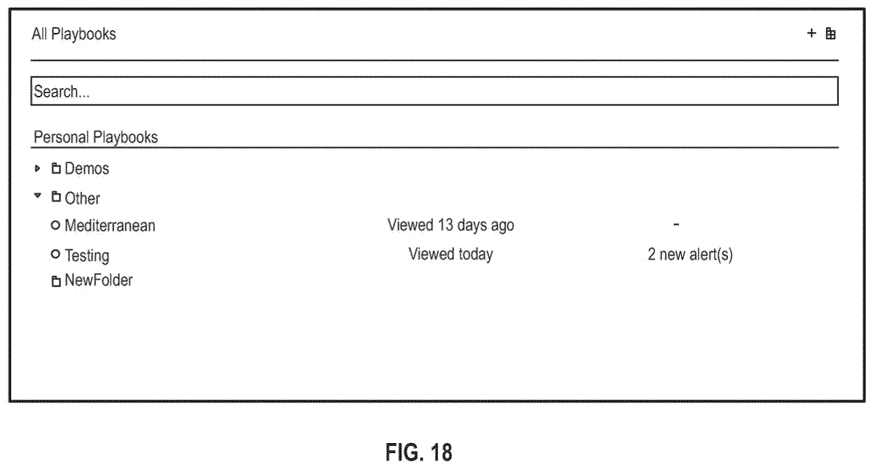

FIG. 18 illustrates an example interface with playbooks of the mission space platform. A play book is a project workspace for exploring data within mission space. In some implementations, a playbook is associated with, or linked to, one or more mission snapshots. Playbooks can be used to save map configurations, shapes and geofences, timeframe adjustments, filters, watched vessels, and alert rules, where each of these items can be associated with a particular mission session. In some implementations, mission space is used by an organization and the interface of FIG. 18 is an example home page where a user can create, clone, share, rename, and organize playbooks within the organization.

Mission space can host one main organization with one or more sub-organizations. For example, an administrator of mission space can determine a parsing of the organization to divide an organization's users into one or more groups. Mission space can associate one or more playbooks to different sub-organizations or groups to facilitate a more efficient sharing of playbooks amongst certain individuals within an organization as opposed to sharing the playbooks with the entire organization.

Regarding sharing, mission space can include an export function (or button) that, when selected (or clicked), automatically exports a data file of RF geolocations in a given map view. In some implementations, the data file is a GeoJSON file of all the data currently visible in a map view of mission space. The exported data file can be downloaded directly from the mission space platform or directly from a user's web-browser that runs a version of the mission space platform.

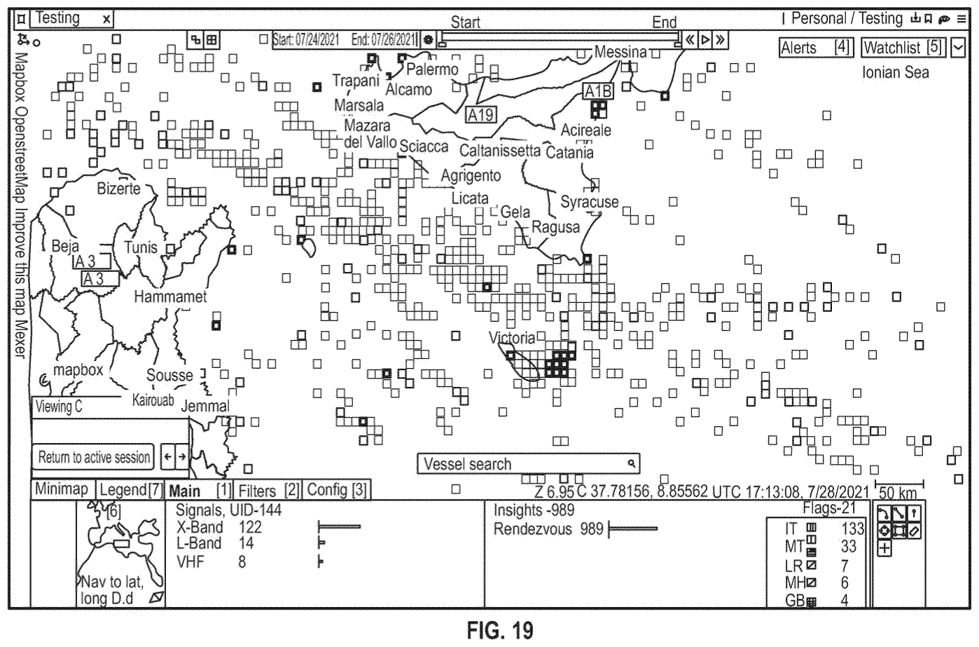

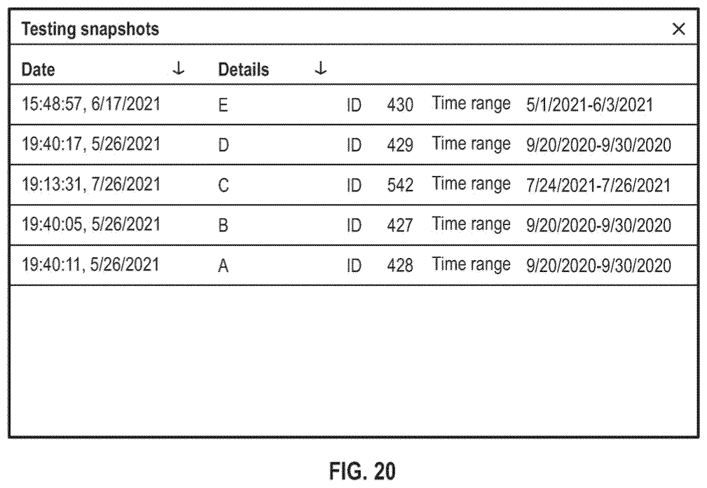

FIG. 19 illustrates a first example interface for a testing feature of the mission space platform. FIG. 20 illustrates a second example interface for testing feature of the mission space platform.

Mission space includes a terrestrial registry implementation that allows for visualization and interaction of a collection of stationary emitters within a given area. An example interface for the terrestrial registry can include an input or control feature that enables users to toggle on identified stationary emitter locations. A similar toggle function can apply to a signal or insight. Additionally, the data accessed via the terrestrial registry can be synced with a timeline such that a user can understand the activity of identified emitters. Mission space can receive inputs indicating user selection of an identified location and present an image of that location/emitter to the user.

FIG. 15 is a block diagram of computing devices 1500, 1550 that may be used to implement the systems and methods described in this document, either as a client or as a server or plurality of servers. Computing device 1500 is intended to represent various forms of digital computers, such as laptops, desktops, workstations, personal digital assistants, servers, blade servers, mainframes, and other appropriate computers. Computing device 1550 is intended to represent various forms of mobile devices, such as personal digital assistants, cellular telephones, smartphones, smartwatches, head-worm devices, and other similar computing devices. The components shown here, their connections and relationships, and their functions, are meant to be exemplary only, and are not meant to limit implementations described and/or claimed in this document.

Computing device 1500 includes a processor 1502, memory 1504, a storage device 1506, a high-speed interface 1508 connecting to memory 1504 and high-speed expansion ports 1510, and a low speed interface 1512 connecting to low speed bus 1514 and storage device 1506. Each of the components 1502, 1504, 1506, 1508, 1510, and 1512, are interconnected using various busses, and may be mounted on a common motherboard or in other manners as appropriate. The processor 1502 can process instructions for execution within the computing device 1500, including instructions stored in the memory 1504 or on the storage device 1506 to display graphical information for a GUI on an external input/output device, such as display 1516 coupled to high speed interface 1508. In other implementations, multiple processors and/or multiple buses may be used, as appropriate, along with multiple memories and types of memory. Also, multiple computing devices 1500 may be connected, with each device providing portions of the disclosed operations (e.g., as a server bank, a group of blade servers, or a multi-processor system).

The memory 1504 stores information within the computing device 1500. In one implementation, the memory 1504 is a computer-readable medium. In one implementation, the memory 1504 is a volatile memory unit or units. In another implementation, the memory 1504 is a non-volatile memory unit or units.

The storage device 1506 is capable of providing mass storage for the computing device 1500. In one implementation, the storage device 1506 is a computer-readable medium. In various different implementations, the storage device 1506 may be a hard disk device, an optical disk device, or a tape device, a flash memory or other similar solid-state memory device, or an array of devices, including devices in a storage area network or other configurations. In one implementation, a computer program product is tangibly embodied in an information carrier. The computer program product includes instructions that, when executed, perform one or more methods, such as those described above. The information carrier is a computer- or machine-readable medium, such as the memory 1504, the storage device 1506, or memory on processor 1502.

The high-speed controller 1508 manages bandwidth-intensive operations for the computing device 1500, while the low speed controller 1512 manages lower bandwidth intensive operations. Such allocation of duties is exemplary only. In one implementation, the high-speed controller 1508 is coupled to memory 1504, display 1516 (e.g., through a graphics processor or accelerator), and to high-speed expansion ports 1510, which may accept various expansion cards (not shown). In the implementation, low-speed controller 1512 is coupled to storage device 1506 and low-speed expansion port 1514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1500 may be implemented in a number of different forms, as shown in the figure. For example, it may be implemented as a standard server 1520, or multiple times in a group of such servers. It may also be implemented as part of a rack server system 1524. In addition, it may be implemented in a personal computer such as a laptop computer 1522. Alternatively, components from computing device 1500 may be combined with other components in a mobile device (not shown), such as device 1550. Each of such devices may include one or more of computing device 1500, 1550, and an entire system may be made up of multiple computing devices 1500, 1550 communicating with each other.

Computing device 1550 includes a processor 1552, memory 1564, an input/output device such as a display 1554, a communication interface 1566, and a transceiver 1568, among other components. The device 1550 may also be provided with a storage device, such as a microdrive or other device, to provide additional storage. Each of the components 1550, 1552, 1564, 1554, 1566, and 1568, are interconnected using various buses, and several of the components may be mounted on a common motherboard or in other manners as appropriate.

The processor 1552 can process instructions for execution within the computing device 1550, including instructions stored in the memory 1564. The processor may also include separate analog and digital processors. The processor may provide, for example, for coordination of the other components of the device 1550, such as control of user interfaces, applications run by device 1550, and wireless communication by device 1550.

Processor 1552 may communicate with a user through control interface 1558 and display interface 1556 coupled to a display 1554. The display 1554 may be, for example, a TFT LCD display or an DEED display, or other appropriate display technology. The display interface 1556 may comprise appropriate circuitry for driving the display 1554 to present graphical and other information to a user. The control interface 1558 may receive commands from a user and convert them for submission to the processor 1552. In addition, an external interface 1562 may be provided in communication with processor 1552, so as to enable near area communication of device 1550 with other devices. External interface 1562 may provide, for example, for wired communication (e.g., via a docking procedure) or for wireless communication (e.g., via Bluetooth or other such technologies).

The memory 1564 stores information within the computing device 1550. In one implementation, the memory 1564 is a computer-readable medium. In one implementation, the memory 1564 is a volatile memory unit or units. In another implementation, the memory 1564 is a non-volatile memory unit or units. Expansion memory 1574 may also be provided and connected to device 1550 through expansion interface 1572, which may include, for example, a SIMM card interface. Such expansion memory 1574 may provide extra storage space for device 1550, or may also store applications or other information for device 1550. Specifically, expansion memory 1574 may include instructions to carry out or supplement the processes described above, and may include secure information also. Thus, for example, expansion memory 1574 may be provided as a security module for device 1550, and may be programmed with instructions that permit secure use of device 1550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product includes instructions that, when executed, perform one or more methods, such as those described above. The information carrier is a computer- or machine-readable medium, such as the memory 1564, expansion memory 1574, or memory on processor 1552. The mission space platform also can be implemented on any number of virtual servers in a contemporary closed infrastructure. Uses typically access the infrastructure via a desktop or laptop computer, however, it also may be accessed by any smartphone.

Device 1550 may communicate wirelessly through communication interface 1566, which may include digital signal processing circuitry in some cases. Communication interface 1566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1568. In addition, short-range communication may occur, such as using a Bluetooth, Wi-Fi, or other such transceiver (not shown). In addition, GPS receiver module 1570 may provide additional wireless data to device 1550, which may be used as appropriate by applications running on device 1550.

Device 1550 may also communicate audibly using audio codec 1560, which may receive spoken information from a user and convert it to usable digital information. Audio codec 1560 may likewise generate audible sound for a user, such as through a speaker, e.g., in a handset of device 1550. Such sound may include sound from voice telephone calls, may include recorded sound (e.g., voice messages, music files, etc.) and may also include sound generated by applications operating on device 1550.

The computing device 1550 may be implemented in a number of different forms, as shown in the figure. For example, it may be implemented as a cellular telephone 1580. It may also be implemented as part of a smartphone 1582, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

As discussed above, systems and techniques described herein can be implemented in a computing system that includes a back-end component, e.g., as a data server, or that includes a middleware component such as an application server, or that includes a front-end component such as a client computer having a graphical user interface or a Web browser through which a user can interact with an implementation of the systems and techniques described here, or any combination of such back-end, middleware, or front-end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, in some embodiments, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A number of embodiments have been described. Nevertheless, it will be understood that various modifications may be made without departing from the spirit and scope of the invention. For example, various forms of the flows shown above may be used, with steps re-ordered, added, or removed. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising: identifying radio frequency (RF) signals among a plurality of data; generating a graphical interface comprising a map of a geographic area, the map comprising a plurality of grid points;
for each RF signal in a first subset of RF signals:
determining a respective geolocation of a corresponding emitter that emits the
RF signal; and
assigning the RF signal and its corresponding emitter to a grid point of the map based on the respective geolocation;
dynamically adjusting, in real time, one or more visual characteristics of a first grid point assigned to a first RF signal and a corresponding first emitter based on new RF information obtained for a region of the geographic area that includes the grid point; and providing the new RF information as an output at the graphical interface by displaying a respective adjustment to each of the one or more visual characteristics of the first grid point.

2. The method of claim 1, wherein each grid point of the plurality of grid points is configured to convey, visually, information about one or more RF signals that correspond to a given emitter that is estimated to have emitted the one or more RF signals.

3. The method of claim 1, further comprising:
generating an adjusted graphical interface comprising a heatmap of the geographic area based on analytics applied to:
i) data about the first subset of RF signals; and
ii) the new RF information, and any associated analytics.

4. The method of claim 3, further comprising:
determining, for each of the plurality of grid points, a respective count of RF emissions detected across different regions of the geographic area, each RF emission being a discrete radio signal.

5. The method of claim 4, further comprising:
determining, for the respective count of RF emissions, at least one of: a frequency, a signal type, or a signal band for one or more discrete radio signals included among the respective count of RF emissions.

6. The method of claim 1, wherein each of the plurality of grid points has a respective set of visual characteristics and generating the adjusted graphical interface comprises:
for each of the plurality of grid points, dynamically adjusting at least one visual characteristic in the set of visual characteristics for the grid point; and
generating a heatmap that reflects, visually and for each grid point, the respective dynamic adjustment to the at least one visual characteristic of the grid point.

7. The method of claim 1, wherein the plurality of grid points and associated subset of RF signals, and dynamically adjusted visual characteristics, are exportable and shared to one or more second users for dynamic adjustment within the defined export of grid points and associated subset of RF signals.

8. A user interface system for identifying and mapping at least one RF emitter on the surface of the Earth comprising:
a source of RF data collected from said at least one RF emitter;
a source of analytical processes;
a source of visual and analytical tools;
a source of external data collections; and
an artificial intelligence module for selectively accessing and processing said RF data, said analytical processes, said visual and analytical tools, and said external data collections;
wherein said artificial intelligence module is operative to generate tracking information for said at least one RF emitter.

9. The user interface system of claim 8, wherein said tracking information comprises at least one of static analytics, streaming analytics and predictive information.

10. The user interface system of claim 8, wherein said artificial intelligence module comprises an unsupervised learning module providing mission thread prediction.

11. The user interface system of claim 10 wherein user behavior is monitored and fed back to the artificial intelligence module for model training and learning.

12. The user interface system of claim 8, wherein said artificial intelligence module is operative to cause delivery of automated alert notifications to one or more defined users for at least one RF emitter based on the artificial intelligence module generated tracking information results.

13. The user interface system of claim 8, wherein the tracking information is collectable at instants of time and is exportable and shareable with one or more additional users for dynamic analysis.

14. The user interface system of claim 8, further comprising a display, wherein said RF data, said analytical processes, said visual and analytical tools, and said external data collections are accessible in real time to provide emitter tracking with geographic and contextual information about the emitter.

15. A method for identifying and mapping at least one RF emitter on the surface of the Earth comprising:
accessing RF data collected from said at least one RF emitter;
accessing analytics;
accessing visual and analytical tools;
accessing at least one data collection from a plurality of external data collections;
utilizing an artificial intelligence module for selectively accessing and processing said RF data, said analytics, said visual and analytical tools, and said external data collections;
whereby tracking information is created by said artificial intelligence module for said at least one RF emitter.

16. The method of claim 15 wherein user behavior is monitored and led back to the artificial intelligence module for model training and learning.

17. The method of claim 15, wherein said artificial intelligence module is operative to cause delivery of automated alert notifications to one or more defined users for at least one RF emitter based on the artificial intelligence module generated tracking information results.

18. The method of claim 15, further comprising:
collecting the tracking information at instants of time, and
exporting and sharing said collected tracking information with one or more additional users for dynamic analysis.

19. The method of claim 15, further comprising displaying said tracking information and one or more of said RF data, said analytical processes, said visual and analytical tools, and said external data collections, in real time to provide emitter tracking with geographic and contextual information about the emitter.

20. A computer program product embodied in a non-transitory machine-readable medium that stores instructions executable by one or more processors as a method for identifying and mapping at least one RF emitter on the surface of the Earth comprising:
accessing RF data collected from said at least one RF emitter;
accessing analytical processes;
accessing visual and analytical tools;
accessing at least one data collection from a plurality of external data collections;
utilizing an artificial intelligence module for selectively accessing and processing said RF data, said analytical processes, said visual and analytical tools, and said external data collections;
whereby tracking information is created by said artificial intelligence module for said at least one RF emitter.
